(19) United States
(12) Patent Application Publication
(10) Pub. No.: US 2023/0222379 A1
(43) Pub. Date: Jul. 13, 2023

(54) MACHINE LEARNING-BASED SYSTEMS AND METHODS FOR OPTIMIZED DATA PRIORITIZATION

(71) Applicant: Optum Services (Ireland) Limited, Dublin (IE)

(72) Inventors: Conor Breen, Dublin (IE); Peter Cogan, Dublin (IE); Anthony R. O'Neill, Dublin (IE); Fadong Yan, Basking Ridge, NJ (US)

(21) Appl. No.: 17/676,576

(22) Filed: Feb. 21, 2022

Related U.S. Application Data
(60) Provisional application No. 63/266,585, filed on Jan. 10, 2022.

(51) Int. Cl. G06N 20/00

(52) U.S. Cl. CPC G06N 20/00

(57) ABSTRACT

Various embodiments of the present invention provide methods, apparatus, systems, computing devices, computing entities, and/or the like for data prioritization. Certain embodiments of the present invention utilize systems, methods, and computer program products that perform prospective prioritization target using at least one of a historical triggering event data, trained prospective prediction machine learning model, and predictive input channels.

### CROSS-REFERENCE TO RELATED APPLICATIONS

This application claims the benefit of and priority to U.S. Provisional Application Ser. No. 63/266,585, filed on Jan. 10, 2022, which is incorporated by reference herein in its entirety.

### BACKGROUND

Various embodiments of the present invention address technical challenges related to performing data prioritization with respect to predictive input entities and disclose innovative techniques for efficiently and effectively performing prospective prioritization of predictive input entities using various predictive data analysis techniques.

### BRIEF SUMMARY

In general, various embodiments of the present invention provide methods, apparatus, systems, computing devices, computing entities, and/or the like for performing prospective prioritization with respect to predictive input entities. Various embodiments of the present invention disclose techniques for prospective prioritization with respect to predictive input entities across predictive input channels.

In accordance with one aspect, a method is provided. In one embodiment, the method comprises: for each predictive input entity of the plurality of predictive input entities, determining a prospective qualifying criteria satisfaction predictive output for the predictive input entity, determining a prospective triggering event occurrence predictive output for the predictive input entity based at least in part on a trained prospective prediction machine learning model, wherein training the prospective prediction machine learning model comprises: identifying a plurality of retrospective events associated with a defined retrospective period, identifying a plurality of prospective events associated with the plurality of retrospective events associated with a defined prospective period, each prospective event of the plurality of prospective events having an event valuation, for each prospective event, determining a prospective-period training utility measure, determining a high-utility subset of the plurality of prospective events based at least in part on each prospective-period training utility measure, determining a periodic ground-truth value for the defined prospective period based at least in part on each event valuation for the high-utility subset, generating training data for the prospective prediction machine learning model based at least in part on the periodic ground-truth value, training the prospective prediction machine learning model based at least in part on the training data, determining a prospective priority score for the predictive input entity based at least in part on the prospective qualifying criteria satisfaction predictive output for the predictive input entity and the prospective triggering event occurrence predictive output for the predictive input entity, and performing prospective prioritization based at least in part on each prospective priority score for a predictive input entity of the plurality of predictive input entities

In accordance with another aspect, a computer program product is provided. The computer program product may comprise at least one computer-readable storage medium having computer-readable program code portions stored therein, the computer-readable program code portions comprising executable portions configured to: for each predictive input entity of the plurality of predictive input entities, determine a prospective qualifying criteria satisfaction predictive output for the predictive input entity, determine a prospective triggering event occurrence predictive output for the predictive input entity based at least in part on a trained prospective prediction machine learning model, wherein training the prospective prediction machine learning model comprises: identifying a plurality of retrospective events associated with a defined retrospective period, identifying a plurality of prospective events associated with the plurality of retrospective events associated with a defined prospective period, each prospective event of the plurality of prospective events having an event valuation, for each prospective event, determining a prospective-period training utility measure, determining a high-utility subset of the plurality of prospective events based at least in part on each prospective-period training utility measure, determining a periodic ground-truth value for the defined prospective period based at least in part on each event valuation for the high-utility subset, generating training data for the prospective prediction machine learning model based at least in part on the periodic ground-truth value, training the prospective prediction machine learning model based at least in part on the training data, determining a prospective priority score for the predictive input entity based at least in part on the prospective qualifying criteria satisfaction predictive output for the predictive input entity and the prospective triggering event occurrence predictive output for the predictive input entity, and perform prospective prioritization based at least in part on each prospective priority score for a predictive input entity of the plurality of predictive input entities.

In accordance with yet another aspect, an apparatus comprising at least one processor and at least one memory including computer program code is provided. In one embodiment, the at least one memory and the computer program code may be configured to, with the processor, cause the apparatus to: for each predictive input entity of the plurality of predictive input entities, determine a prospective qualifying criteria satisfaction predictive output for the predictive input entity, determine a prospective triggering event occurrence predictive output for the predictive input entity based at least in part on a trained prospective prediction machine learning model, wherein training the prospective prediction machine learning model comprises: identifying a plurality of retrospective events associated with a defined retrospective period, identifying a plurality of prospective events associated with the plurality of retrospective events associated with a defined prospective period, each prospective event of the plurality of prospective events having an event valuation, for each prospective event, determining a prospective-period training utility measure, determining a high-utility subset of the plurality of prospective events based at least in part on each prospective-period training utility measure, determining a periodic ground-truth value for the defined prospective period based at least in part on each event valuation for the high-utility subset, generating training data for the prospective prediction machine learning model based at least in part on the periodic ground-truth value, training the prospective prediction machine learning model based at least in part on the training data, determining a prospective priority score for the predictive input entity based at least in part on the prospective qualifying criteria satisfaction predictive output for the predictive input entity and the prospective triggering event occurrence predictive output for the predictive input entity, and perform prospective prioritization based at least in part on each prospective priority score for a predictive input entity of the plurality of predictive input entities.

### BRIEF DESCRIPTION OF THE SEVERAL VIEWS OF THE DRAWINGS

Reference will now be made to the accompanying drawings, which are not necessarily drawn to scale, and wherein:

FIG. 1 provides an exemplary overview of an architecture that can be used to practice embodiments of the present invention.

FIG. 2 provides an example prospective prioritization computing entity in accordance with some embodiment discussed herein.

FIG. 3 provides an example client computing entity in accordance with some embodiments discussed herein.

FIG. 4 is a flowchart diagram of an example process for prioritizing data with respect to a plurality of predictive input entities in accordance with some embodiments discussed herein.

FIG. 5 is an exemplary organizational diagram defining types of predictive input channels in accordance with some embodiments discussed herein.

FIG. 6 provides an operational example of predictive input channels and corresponding models which may be used for generating a prospective qualifying criteria satisfaction likelihood output in accordance with some embodiments discussed herein.

FIG. 7 provides a flowchart diagram of an example process for a trained rule-parameterized criteria satisfaction model in accordance with some embodiments discussed herein.

FIG. 8 provides a flowchart diagram of an example process for a trained criteria satisfaction model in accordance with some embodiments discussed herein.

FIG. 9 provides an operational example of predictive input channels and corresponding models which may be used for generating a prospective triggering event occurrence predictive output in accordance with some embodiments discussed herein.

FIG. 10 provides a flowchart diagram of an example process for a trained event-based historical interpolation model in accordance with some embodiments discussed herein.

FIG. 11 provides a flowchart diagram of an example process for training a prospective prediction machine learning model in accordance with some embodiments discussed herein.

FIG. 12 provides a flowchart diagram of an example process for generating training data for a prospective prediction machine learning model in accordance with some embodiments discussed herein.

FIG. 13 provides an operational example of training data fields for a prospective prediction machine learning model in accordance with some embodiments discussed herein.

FIG. 14 provides an operational example of predictive input channels and corresponding models which may be used for generating a prospective cost predictive output in accordance with some embodiments discussed herein.

FIGS. 15A-15B provides an operational example for performing prospective prioritization in accordance with some embodiments discussed herein.

FIG. 16 provides an operational example of a user interface depicting prospective prioritization data in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### Overview and Technical Advantages

Various embodiments of the present invention disclose techniques for more efficiently and reliably performing prospective prioritization with respect to a plurality of predictive input entities. For example, various embodiments of the present invention disclose techniques for performing prospective prioritization utilizing one or more supervised machine learning models. For example, according to some embodiments of the present invention, prospective prioritization with respect to a plurality of predictive input entities can be performed by (i) determining a prospective qualifying criteria satisfaction predictive output for each predictive input entity; (ii) determining a prospective triggering event occurrence predictive output for each predictive input entity based at least on a trained prospective prediction machine learning model; (iii) and generating a prospective priority score for each predictive input entity based at least in part on the prospective qualifying criteria satisfaction predictive output and the prospective triggering event occurrence predictive output. The prospective prediction machine learning model utilizes training data and prediction operations that may, in at least some embodiments, reduce or eliminate the need for computationally expense training operations in order to generate the prospective triggering event occurrence predictive output, which in turn is used in generating the prospective priority score. By reducing or eliminating the noted training operations, various embodiments of the present invention: (i) reduce or eliminate the computational operations needed for training and thus improves the computational efficiency of performing prospective prioritization with respect to a plurality of predictive input entities, (ii) reduce or eliminate the need for storage resources to train/generate prospective prediction machine learning models and thus improves storage efficiency of performing prospective prioritization with respect to a plurality of predictive input entities, and (iii) reduce or eliminate the need for transmitting extensive training data needed to generate prospective prediction machine learning models and thus improves transmission/network efficiency of performing prospective prioritization with respect to a plurality of predictive input entities.

Moreover, various embodiments of the present invention disclose techniques for more efficiently and reliably performing data prioritization across a plurality of predictive input channels. By facilitating efficient and reliable data prioritization various embodiments of the present invention improve data retrieval efficiency, as well as data storage efficiency of various data storage systems. Aggregating data from a plurality of channels into a single prioritized channel facilitates more efficient storage of such data, for example enabling consolidation of data across various databases and/or across various database tables. This, in turn, reduces storage needs of various existing data storage systems. Furthermore, performing prospective prioritization across channels enables faster and more reliable retrieval of the most significant portions of data in response to data queries. This, in turn, increases the efficiency and reliability of data retrieval operations and/or data query processing operations across various data storage systems, such as various data storage systems that act as server devices in client-server data storage architectures. Via the noted advantages, various embodiments of the present invention make substantial technical contributions to the fields of data prioritization and database systems in particular and healthcare-related predictive data analysis in general.

An exemplary application of various embodiments of the proposed invention relate to inventory prioritization in a coordination of benefits (COB) scenario based at least in part on the likelihood that a member has more than one insurance coverage (e.g., dual coverage) and the likelihood that that member would submit a claim and/or a high-value claim in a defined subsequent time period. Coordination of benefits investigations generally aim to determine/identify members who may have more than one insurance coverage (e.g., coverage with another insurance company or with a government program) and to determine/identify primary insurers (e.g., primary payer) with the purpose of redirecting submitted claims to the primary insurer, so as to yield medical cost savings (e.g., avoid duplicate payments and reduce the cost of insurance premiums for members). However existing technology—that focus on inventory prioritization based primarily on the likelihood of COB/likelihood of a member having more than one insurance coverage—is incapable of yielding optimal cost savings, given that while a member may have more than one insurance coverage, that member may never submit a claim or may only submit low-value claims. Moreover, prioritizing inventory based alone on the likelihood that a member has more than one coverage causes resources to be wasted, particularly where the member never submits a claim or submits only low-value claims.

Various embodiments of the present invention make important technical contributions to improving resource-usage efficiency of post-prediction systems by using prospective priority scores to set the number of allowed computing entities used by the noted post-prediction systems. For example, in some embodiments, a prospective prioritization computing entity determines D investigation classifications for D predictive input entities based at least in part on the D prospective priority scores for the D predictive input entities. Then, the count of D predictive input entities that are associated with an affirmative investigation classification, along with a resource utilization ratio for each document data object, can be used to predict a predicted number of computing entities needed to perform post-prediction processing operations (e.g., automated investigation operations, such as automated COB investigation operations) with respect to the D predictive input entities. For example, in some embodiments, the number of computing entities needed to perform post-prediction processing operations (e.g., automated investigation operations) with respect to D predictive input entities can be determined based at least in part on the output of the equation: R=ceil(Σₖ^{k=K}urₖ), where R is the predicted number of computing entities needed to perform post-prediction processing operations with respect to the D predictive input entities, ceil( ) is a ceiling function that returns the closest integer that is greater than or equal to the value provided as the input parameter of the ceiling function, k is an index variable that iterates over K predictive input entities among the D document data that are associated with affirmative investigative classifications, and urₖ is the estimated resource utilization ratio for a kth predictive input entity that may be determined based at least in part on a count of utterances/tokens/words in the kth predictive input entity. In some embodiments, once R is generated, a prospective prioritization computing entity can use R to perform operational load balancing for a server system that is configured to perform post-prediction processing operations (e.g., automated investigation operations) with respect to D predictive input entities. This may be done by allocating computing entities to the post-prediction processing operations if the number of currently-allocated computing entities is below R, and deallocating currently-allocated computing entities if the number of currently-allocated computing entities is above R.

### Definitions of Certain Terms

The term “predictive input entity” may refer to a data object describing an entity in relation to which one or more predictive tasks are performed. In some example embodiments, the data object may describe a member who receives healthcare services or products (or any other type of service or product) rendered by a provider and/or who relies on financing from a health insurance insurer to cover the costs of the rendered health services or products. A member may be associated with the health insurance insurer and may be considered a member of a program associated with the health insurance insurer.

The term “predictive input channel” may refer to an inventory of data objects describing and/or corresponding with a plurality of predictive input entities (e.g., data objects describing members, member records/profiles, member identifiers, and/or the like). Each data object may store/represent feature data associated with a predictive input entity. The inventory of a predictive input channel may be generated based at least in part on probabilistic models and/or deterministic rules. The inventory of the predictive input channel may be generated responsive to one or more events which trigger an interest with respect to a predictive input entity (e.g., real-time events, triggering event occurrences, and/or the like) or may be prospective (e.g., based at least in part on historical triggering event data). A predictive input channel may be configured to determine (e.g., prioritize, classify, select, organize, arrange, and/or the like) predictive input entities based at least in part on feature data (e.g., member information and/or data and/or the like).

The term “model-based prospective channel” may refer to a predictive input channel in which inventory is generated based at least in part on a probabilistic model that may be trained on historic data associated with a plurality of predictive input entities. For example, the inventory of the model-based prospective channel may be generated based at least in part on feature data (e.g., member information/data) associated with a plurality of predictive input entities.

The term “rule-based prospective channel” may refer to a predictive input channel in which inventory is generated by applying one or more deterministic rules (e.g., rules associated with feature data of a plurality of predictive input entities). The inventory of a rule-based prospective channel may be based at least in part on feature data (e.g., member information/data) associated with the predictive input entities.

The term “model-based real-time channel” may refer to a predictive input channel in which inventory is generated based at least in part on a probabilistic model that may be trained on historic data associated with a plurality of predictive input entities. For example, the inventory of the model-based real-time channel may be generated responsive to one or more events which trigger an interest with respect to a predictive input entity (e.g., real-time events, triggering event occurrences, and/or the like).

The term “rule-based real-time channel” may refer to a predictive input channel in which inventory is generated by applying one or more deterministic rules (e.g., rules associated with feature data of a plurality of predictive input entities). For example, the inventory of the rule-based real-time channel may be generated in response to one or more events which trigger an interest with respect to a predictive input entity (e.g., real-time events, triggering event occurrences, and/or the like).

The term “prospective qualifying criteria satisfaction predictive output” may refer to a data object describing a level of interest with respect to an event which triggers an interest with respect to a predictive input entity. For example, the prospective qualifying criteria satisfaction predictive output may represent a likelihood that feature data associated with the predictive input entity satisfies one or more criteria or rule effectiveness parameters. The criteria and/or rule effectiveness parameters may be based at least in part on historic rule effectiveness data. In some embodiments, if an event which triggers an interest with respect to a predictive input entity occurs, the level of interest may be deemed certain/absolute. In some embodiments, the data object may store/describe criteria-related feature data associated with a predictive input entity. For example, criteria-related feature data may comprise demographic data satisfying one or more rules associated with a predictive input entity (e.g., a person over the age of 65, a person located in Georgia, a person who is married, a person who is employed and/or the like). Some criteria-related feature data may be indicative of a high level of interest with respect to an event which triggers an interest with respect to a predictive input entity. For example, in the context of a coordination of benefits scenario, the prospective qualifying criteria satisfaction predictive output may be a likelihood (e.g., probability) that a given member is eligible for insurance coverage through another insurer. In that context, a member that is married may be more likely to have additional insurance. One or more criterion/rule effectiveness parameters may be used to generate the prospective qualifying criteria satisfaction predictive output with respect to each predictive input entity. In some embodiments, the prospective qualifying criteria satisfaction predictive output may be determined using a trained rule-parameterized criteria satisfaction model which is configured to process per-entity criteria related feature data associated with a predictive input entity in accordance with one or more model parameters comprising one or more rule effectiveness parameters.

The term “prospective triggering event occurrence” may refer to a data object describing an event which triggers an interest with respect to a predictive input entity. In some example embodiments, the data object may describe a request for payment/reimbursement for services rendered, materials used, equipment provided, and/or the like (e.g., a claim filing). In various embodiments, a claim may be a request for payment/reimbursement for a consultation with a primary care doctor, a medical procedure or an evaluation performed by an orthopedic surgeon, a laboratory test performed by a laboratory, a surgery, durable medical equipment provided to an injured member, medications or other materials used in the treatment of a member, and/or the like.

The term “prospective triggering event occurrence predictive output” may refer to a data object indicating a likelihood of an event which triggers an interest with respect to a predictive input entity. The prospective triggering event occurrence predictive output may be determined using a trained event-based historical interpolation model configured to process per-entity historical triggering event data associated with a predictive input entity to generate a hypothesis for determining the prospective triggering event occurrence predictive output with respect to the predictive input entity. For example, the prospective triggering event occurrence may be a claim filing prediction (e.g., probability of claim filing) with respect to a predictive input entity within a period of time (e.g., the next three months or six months). For example, the prospective triggering event occurrence may be a high-value claim filing prediction (e.g., probability of high-value claim filing) with respect to a predictive input entity within a period of time (e.g., the next three months or six months). The data object may store/describe historical triggering event data associated with the predictive input entity. The historical triggering event data may comprise feature data (e.g., claim data and/or member information/data) corresponding with the likelihood of the prospective triggering event occurrence. For example, claim data may refer to a number of or frequency of historical triggering event occurrences (e.g., doctor visits, hospital stays, and/or the like). Member information/data may include disease profiles, chronic conditions and/or the like. Feature data having certain characteristics may indicate a higher likelihood of a prospective triggering event occurrence (e.g., likelihood of a claim filing). The prospective triggering event occurrence predictive output may be determined based at least in part on a supervised machine learning model (e.g., a neural network machine learning model). In some embodiments, the supervised machine learning model may utilize machine learning algorithms such as support vector machines, linear regression, logistic regression, naïve Bayes classifiers, decision trees and the like. In some embodiments, the prospective triggering event occurrence predictive output may be determined based at least in part on a trained prospective prediction machine learning model.

The term “prospective prediction machine learning model” may refer to a data object that is configured to describe parameters, hyper-parameters, and/or defined operations of a model that is configured to generate a prospective triggering event occurrence predictive output for a predictive input entity. In some embodiments, the prospective prediction machine learning model is a supervised machine learning model (e.g., a neural network model, binary classification model, or the like) that is trained using labeled data, where the supervised machine learning model is configured to generate a prospective triggering event occurrence predictive output, where the prospective triggering event occurrence predictive output is configured to be used to determine a prospective priority score, which is in turn used to perform optimized prospective prioritization. In some embodiments, the respiratory quality evaluation machine learning model is an unsupervised machine learning model (e.g., a clustering model). In some embodiments, the inputs to a prospective prediction machine learning model include one or more input features, which may be a vector or a matrix.

The term “prospective event” may refer to a data object that describes a prospective triggering event occurrence (e.g., an event which triggers an interest with respect to a predictive input entity) that is associated with a defined prospective period. In some example embodiments, the data object may describe a request for payment/reimbursement for service rendered, materials used, equipment provided, and/or the like (e.g., claim filing) that occurred during a defined prospective period. In various embodiments, a claim may be a request for payment/reimbursement for a consultation with a primary care doctor, a medical procedure or an evaluation performed by an orthopedic surgeon, a laboratory test performed by a laboratory, a surgery, durable medical equipment provided to an injured member, medications or other materials used in the treatment of a member, and/or the like. For example, a prospective event may describe a triggering event (e.g., claim filing) that occurred during a defined prospective period.

The term “retrospective event” may refer to data object that describes a prospective triggering event occurrence (e.g., an event which triggers an interest with respect to a predictive input entity) that is associated with a defined retrospective period. In some example embodiments, the data object may describe a request for payment/reimbursement for service rendered, materials used, equipment provided, and/or the like (e.g., claim filing) that occurred during a defined retrospective period. In various embodiments, a claim may be a request for payment/reimbursement for a consultation with a primary care doctor, a medical procedure or an evaluation performed by an orthopedic surgeon, a laboratory test performed by a laboratory, a surgery, durable medical equipment provided to an injured member, medications or other materials used in the treatment of a member, and/or the like. For example, a retrospective event may describe a triggering event (e.g., claim filing) that occurred during a defined retrospective period (e.g., the first 24 months of an observed period).

The term “prospective-period training utility measure” may refer to a data object that describes an estimated/predicted utility of training a prospective prediction machine learning model using a corresponding prospective event. In some embodiments, a prospective prioritization computing entity determines a prospective-period utility measure for a prospective event based at least in part on the event valuation for the prospective event. In some example embodiments, to determine prospective-period training utility measure for a given prospective event, the prospective prioritization computing entity determines whether the prospective event satisfies a predefined measure (e.g., monetary amount, medical visit type, claim type, and/or the like), where prospective events that satisfy the predefined measure are deemed high-utility and prospective events that do not satisfy the predefined measure are deemed low-utility.

The term “retrospective-period training utility measure” may refer to a data object that describes an estimated/predicted utility of training a prospective prediction machine learning model using a corresponding retrospective event. In some embodiments, a prospective prioritization computing entity determines a retrospective-period training utility measure for a retrospective event based at least in part on the event valuation for the retrospective event. In some example embodiments, to determine retrospective-period training utility measure for a given retrospective event, the prospective prioritization computing entity determines whether the retrospective event satisfies a predefined measure (e.g., monetary amount, medical visit type, claim type, and/or the like), where retrospective events that satisfy the predefined measure are deemed high-utility and retrospective events that do not satisfy the predefined measure are deemed low-utility.

The term “training input entity” may refer to a data object describing an entity of a plurality of entities in relation to which a machine learning model (e.g., prospective prediction machine learning model) is trained. In some example embodiments, the data object may describe a member who receives healthcare services or products (or any other type of service or product) rendered by a provider and/or who relies on financing from a health insurance insurer to cover the costs of the rendered health services or products. A member may be associated with the health insurance insurer and may be considered a member of a program associated with the health insurance insurer.

The term “prospective cost predictive output” may refer to a data object describing a magnitude prediction corresponding with an event which triggers an interest with respect to a predictive input entity. The magnitude prediction may be an inferred value (e.g., representing a prospective cost prediction) or an actual value (e.g., representing a real value corresponding with an event in real-time). Additionally, and/or alternatively, the prospective cost predictive output may represent a cumulative value over time associated with a predictive input entity.

The prospective cost predictive output may comprise a maximal triggering event occurrence prediction value, which is the larger value of the inferred prospective cost predictive output and the real-time prospective cost predictive output. The prospective cost predictive output may be determined based at least in part on a supervised machine learning model (e.g., a neural network machine learning model). The supervised machine learning model may be trained on features/feature sets (e.g., historical cost data). In some embodiments, historical cost data may comprise claim features. Example claim features may include a claim ID and the date a claim was received—e.g., Dec. 14, 2021, at 12:00:00 μm and time stamped as 2021 Dec. 14 12:00:00. The claim features may also include one or more diagnostic codes, treatment codes, treatment modifier codes, and/or the like. Such codes may be any code, such as Current Procedural Terminology (CPT) codes, billing codes, Healthcare Common Procedure Coding System (HCPCS) codes, ICD-10-CM Medical Diagnosis Codes, and/or the like. In some embodiments, the supervised machine learning model may utilize machine learning algorithm such as support vector machines, linear regression, logistic regression, naïve Bayes classifiers, decision trees, gradient boosting machines, and the like. The inferred prospective cost predictive output may be determined using a trained prospective cost prediction model. In some embodiments, a trained prospective cost prediction model may refer to a supervised machine learning model configured to process historical cost data associated with a plurality of predictive input entities to generate a hypothesis for determining a prospective cost predictive output with respect to a predictive input entity.

The term “prospective prioritization system” may refer to a system configured to perform predictive tasks with respect to a plurality of predictive input entities. In some embodiments, the prospective prioritization system may be configured to generate a prospective priority score representing a combined likelihood of a prospective qualifying criteria satisfaction (e.g., coordination of benefits) and likelihood of a prospective triggering event occurrence (e.g., a claim filing/high-value claim filing) with respect to a predictive input entity based at least in part on the outputs of a plurality of predictive tasks. In example embodiments, the predictive tasks may include determining a prospective qualifying criteria satisfaction predictive output, determining a prospective triggering event occurrence predictive output, determining a prospective cost predictive output, and/or the like. The prospective priority score may comprise an aggregated output of the predictive tasks. For example, an arithmetic ensemble model aggregating the output of the predictive tasks may be utilized to generate the prospective priority score. In an example embodiment, the arithmetic ensemble model may comprise a weighted sum. In some embodiments, some of the outputs of the predictive tasks may be substituted with static averages.

In an example embodiment, the prospective qualifying criteria satisfaction predictive output and the prospective triggering event occurrence predictive output may be aggregated to generate the prospective priority score in accordance with the following equation: Score=(Prospective qualifying criteria satisfaction predictive output)×(Prospective triggering event occurrence predictive output). In an example embodiment, the prospective qualifying criteria satisfaction predictive output, the prospective triggering event occurrence predictive output, and the prospective cost predictive output may be aggregated to generate the prospective priority score in accordance with the following equation: Score=(Prospective qualifying criteria satisfaction predictive output)×(Prospective triggering event occurrence predictive output)×(Prospective cost predictive output).

In some embodiments, the prospective prioritization system may determine a predictive input channel comprising an inventory of data objects, each data object describing a predictive input entity, and train one or more probabilistic or deterministic machine learning models (e.g., supervised machine learning models) to perform predictive tasks (e.g., the prospective qualifying criteria satisfaction predictive output, the prospective triggering event occurrence predictive output, and/or the prospective cost predictive output). The prospective prioritization system may perform predictive tasks in relation to each predictive input entity in order to determine a prospective priority score for each predictive input entity. The prospective prioritization system may prioritize the inventories of one or more predictive input channels in accordance with the determined prospective priority scores corresponding with each predictive input entity. The prospective prioritization system may prioritize the inventory in a continuous manner by combining real-time and prospective channels to generate a single prioritized channel and/or one or more queues.

The term “investigation queue” may refer to a data object that describes an ordering of a plurality of data objects describing predictive input entities and corresponding prospective priority scores (e.g., prospective prioritization scores) based at least in part on a portion of the single prioritized channel. In some embodiments, the prospective prioritization system may be configured to generate one or more API-based data objects corresponding with the single prioritized channel and/or the one or more queues. The prospective prioritization system may provide (e.g., transmit, send) the one or more API-based data objects representing at least a portion of the single prioritized channel and/or the one or more queues to an end user interface (e.g., an investigation agent user interface) for display

The term “coordination of benefits” may refer to a scenario in which a member of one health insurance company has additional coverage elsewhere. The additional coverage may be with another commercial health insurance company or with a government program (e.g., Medicare or Medicaid). Coordination of benefits enables insurance companies to determine/identify primary insurers, avoid duplicate payments, and reduce the cost of insurance premiums for members.

The term “member record/profile” may refer to a data object storing and/or providing access to member information/data. The member record/profile may also comprise member information/data, member features, and/or similar words used herein interchangeably that can be associated with a given member, claim, and/or the like. In some embodiments, member information/data can include age, gender, employment status, known health conditions, home location, profession, access to medical care, medical history, claim history, member identifier (ID), and/or the like. Member information/data may also include marital status, employment status, employment type, socioeconomic information/data (e.g., income information/data), relationship to the primary insured, insurance product information/data, insurance plan information/data, member classifications, language information/data, and/or the like.

The term “member identifier” may refer to a data object configured to uniquely identify/determine the member (e.g., member identifier, user identifier, and/or the like), a username, user contact information/data (e.g., name (John Doe), one or more electronic addresses such as emails, instant message usernames, social media user name, and/or the like), member preferences, member account information/data, member credentials, information/data identifying/determining one or more member computing entities corresponding to the member, and/or the like. As noted, each member record/profile may correspond to a unique username, unique user identifier (e.g., 11111111), access credentials, and/or the like.

The term “investigation agent” may refer to a user (e.g., a human investigation agent) or a programmatic investigation agent (e.g., an artificial intelligence agent). Prospective prioritization may comprise assigning one or more predictive input entities to one of a plurality of investigation agents based at least in part on the prospective priority score of the predictive input entity and causing each investigation agent to process a related subset of the plurality of predictive input entities that is associated with the investigation agent. The system may generate an investigation agent user interface for each investigation agent that describes one or more investigation queue features of the related subset associated with the investigation agent. A queue may be assigned to an investigation agent. The user may navigate an investigation agent user interface by operating a user computing entity. Through the investigation agent user interface, the user (e.g., human investigation agent) may view and access claim inventory, claim information/data, member information/data, provider information/data, and/or the like. To do so, the prospective prioritization system may provide access to the system via a user profile that has been previously established and/or stored. In an example embodiment, a user profile comprises user profile information/data, such as a user identifier configured to uniquely identify the user, a username, user contact information/data (e.g., name, one or more electronic addresses such as emails, instant message usernames, social media user names, and/or the like), user preferences, user account information/data, user credentials, information/data identifying one or more user computing entities corresponding to the user, and/or the like.

The term “training data field” may refer to a data object that describes one or more input properties of a predictive input entity along with one or more ground-truth event labels for the predictive input entity. For example, training data field may describe one or more input properties of a predictive input entity along with a ground-truth event label, where the ground truth event label for the predictive input entity may describe whether the predictive input entity is recorded to have filed a claim/high-value claim within a prospective period or not filed a claim/high-value claim within the prospective period. For example, a particular training data field may describe one or more properties of a member predictive input entity (e.g., medical claim history of the member predictive input entity, prescription claim history of the member predictive input entity, medical history of the member predictive input entity, demographic information of the member predictive input entity, and/or the like) along with the ground-truth event label that describes whether the member predictive input entity has filed a claim or not filed a claim within a prospective period.

### Computer Program Products, Methods, and Computing Entities

Embodiments of the present invention may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all non-transitory computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like). A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

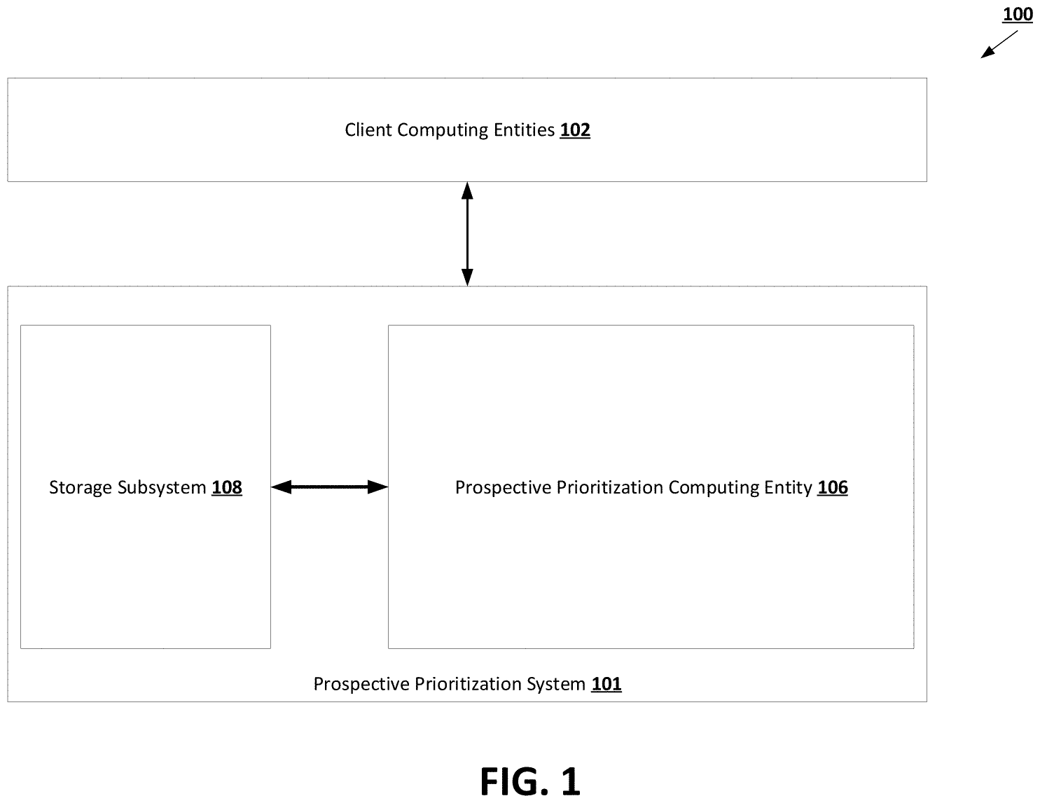

FIG. 1 is a schematic diagram of an example architecture 100 for performing prospective prioritization across a plurality of predictive input channels. The architecture 100 includes a prospective prioritization system 101 configured to receive requests from the client computing entities 102, process the requests to generate query outputs (e.g., predictive outputs), and provide the query outputs to the client computing entities 102. In some embodiments, prospective prioritization system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), and/or the like, as well as any hardware, software, and/or firmware required to implement it (such as, e.g., network routers, and/or the like).

The prospective prioritization system 101 may include a prospective prioritization computing entity 106 and a storage subsystem 108. The prospective prioritization computing entity 106 may be configured to process the requests to generate query outputs and provide the query outputs to the client computing entities 102. The storage subsystem 108 may be configured to store at least a portion of input data utilized by the prospective prioritization computing entity 106 to perform predictive tasks and prospective prioritization. The storage subsystem 108 may further be configured to store at least a portion of data (e.g., feature data) utilized by the prospective prioritization computing entity 106 to perform automated prospective prioritization.

The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Prospective Prioritization Computing Entity

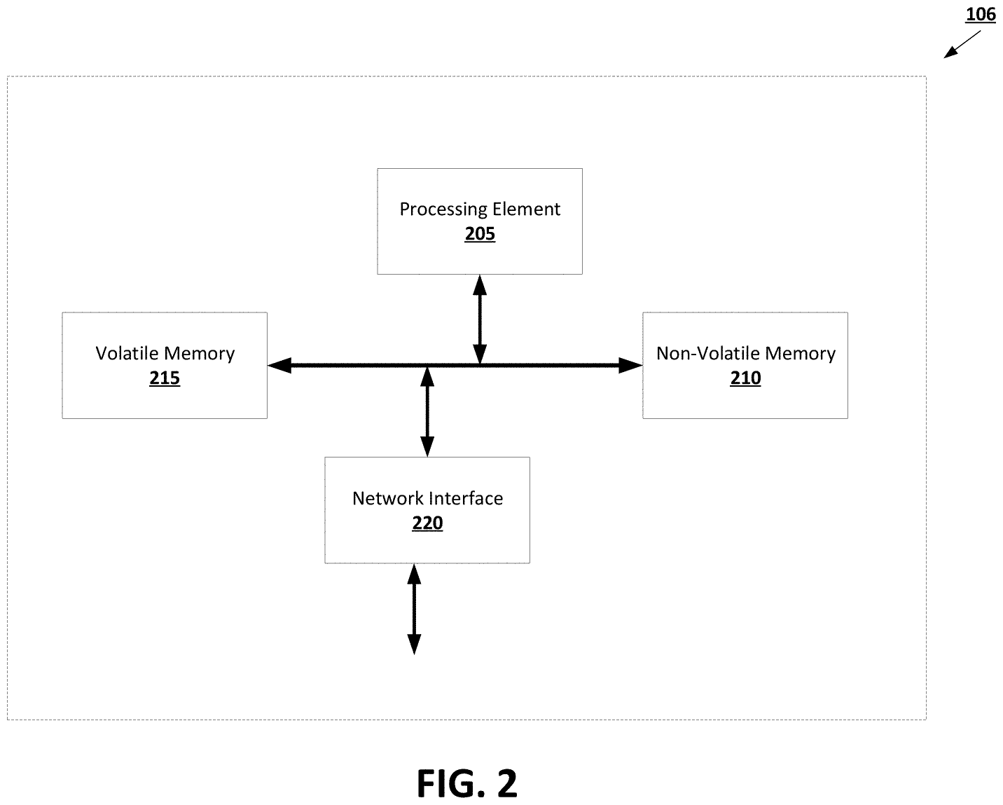

FIG. 2 provides a schematic of a prospective prioritization computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

As indicated, in one embodiment, the prospective prioritization computing entity 106 may also include one or more network interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the prospective prioritization computing entity 106 may include or be in communication with one or more processing elements 205 (also referred to as processors, processing circuitry, and/or similar terms used herein interchangeably) that communicate with other elements within the prospective prioritization computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the prospective prioritization computing entity 106 may further include or be in communication with non-volatile media (also referred to as non-volatile storage, memory, memory storage, memory circuitry, and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the prospective prioritization computing entity 106 may further include or be in communication with volatile media (also referred to as volatile storage, memory, memory storage, memory circuitry, and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the prospective prioritization computing entity 106 with the assistance of the processing element 205 and operating system.

As indicated, in one embodiment, the prospective prioritization computing entity 106 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the prospective prioritization computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the prospective prioritization computing entity 106 may include or be in communication with one or more input elements, such as a keyboard input, a mouse input, a touch screen/display input, motion input, movement input, audio input, pointing device input, joystick input, keypad input, and/or the like. The prospective prioritization computing entity 106 may also include or be in communication with one or more output elements (not shown), such as audio output, video output, screen/display output, motion output, movement output, and/or the like.

### Exemplary Client Computing Entity

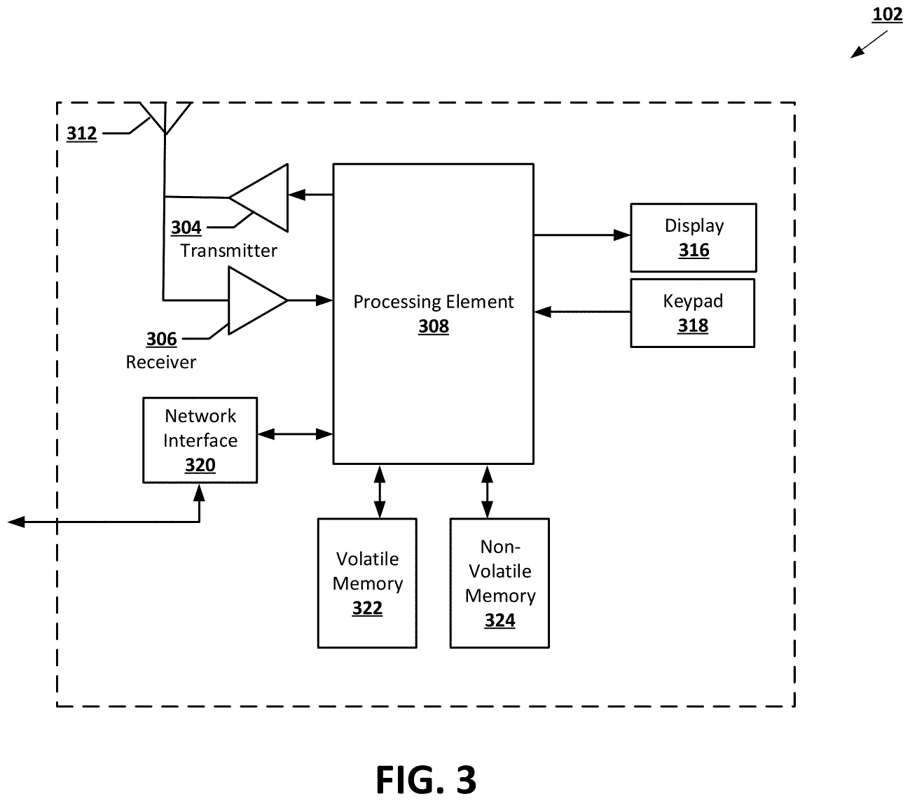

FIG. 3 provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the prospective prioritization computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the prospective prioritization computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the prospective prioritization computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the prospective prioritization computing entity 106 and/or various other computing entities.

In another embodiment, the client computing entity 102 may include one or more components or functionalities that are the same or similar to those of the prospective prioritization computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example System Operation

As described below, various embodiments of the present invention address technical challenges related to efficiently and effectively performing prospective prioritization with respect to a plurality of predictive input entities. For example, various embodiments of the present invention disclose techniques for performing prospective prioritization utilizing one or more supervised machine learning models. For example, according to some embodiments of the present invention, prospective prioritization with respect to a plurality of predictive input entities can be performed by (i) determining a prospective qualifying criteria satisfaction predictive output for each predictive input entity; (ii) determining a prospective triggering event occurrence predictive output for each predictive input entity based at least in part on a trained prospective prediction machine learning model; (iii) and generating a prospective priority score for each predictive input entity based at least in part on the prospective qualifying criteria satisfaction predictive output and the prospective triggering event occurrence predictive output. The prospective prediction machine learning model utilizes training data and prediction operations that may, in at least some embodiments, reduce or eliminate the need for computationally expense training operations in order to generate the prospective triggering event occurrence predictive output, which in turn is used in generating the prospective priority score. By reducing or eliminating the noted training operations, various embodiments of the present invention: (i) reduce or eliminate the computational operations needed for training and thus improves the computational efficiency of performing prospective prioritization with respect to a plurality of predictive input entities; (ii) reduce or eliminate the need for storage resources to train/generate prospective prediction machine learning models and thus improves storage efficiency of performing prospective prioritization with respect to a plurality of predictive input entities; and (iii) reduce or eliminate the need for transmitting extensive training data needed to generate prospective prediction machine learning models and thus improves transmission/network efficiency of performing prospective prioritization with respect to a plurality of predictive input entities.

Moreover, various embodiments of the present invention disclose techniques for more efficiently and reliably performing data prioritization across a plurality of predictive input channels. Existing systems consist of independently managed predictive input channels in which inventory may be generated based at least in part on real-time rules, real-time models, prospective rules, or prospective models. Particular combinations of predictive tasks performed using corresponding models are described herein. However, a person of ordinary skill in the art will recognize that data prioritization in relation to a plurality of predictive input entities across predictive input channels may be performed using other combinations and models.

By facilitating efficient and reliable prospective prioritization, various embodiments of the present invention improve data retrieval efficiency, as well as data storage efficiency of various data storage systems. Generating a single prioritized channel from a plurality of predictive input channels facilitates more efficient storage of data, for example by enabling consolidation of information across various databases and/or across various database tables. This in turn reduces storage needs of various existing data storage systems. Furthermore, prioritization across channels enables faster and more reliable retrieval of data in response to data queries and for further operations. This in turn increases the efficiency and reliability of data retrieval operations and/or data query processing operations across various data storage systems, such as various data storage systems that act as server devices in client-server data storage architectures. Via the noted advantages, various embodiments of the present invention make substantial technical contributions to the fields of data prioritization and database systems in particular and healthcare-related predictive data analysis in general.

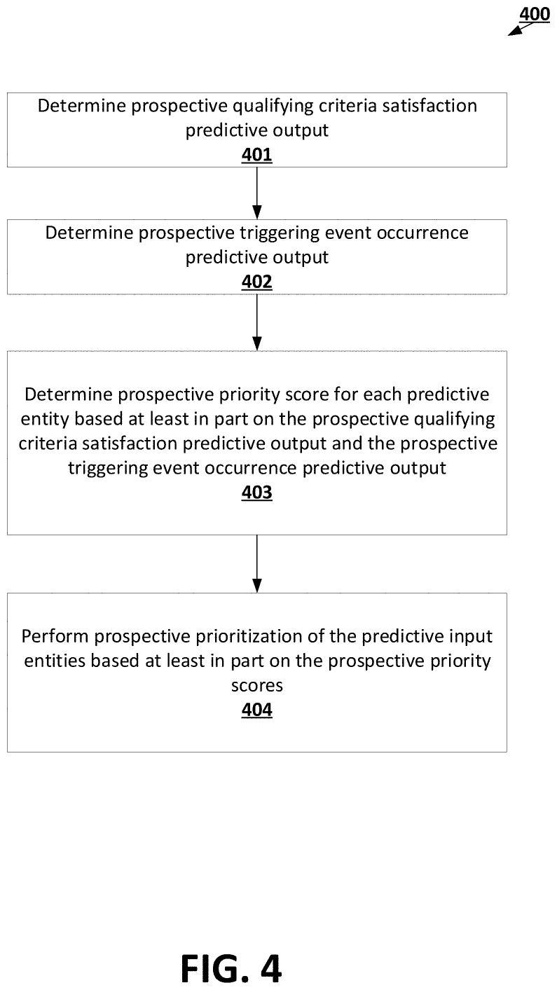

FIG. 4 is a flow chart diagram of an example process 400 for data prioritization with respect to a plurality of predictive input entities. Via the various steps/operations of the process 400, the prospective prioritization computing entity 106 can efficiently and reliably process and aggregate data from a plurality of predictive input channels, determine a prospective priority score for each of a plurality of predictive input entities, and perform prospective prioritization with respect to the predictive input entities. While various embodiments of the present invention may describe performing multiple techniques using a singular computing entity, a person of ordinary skill in the relevant technology will recognize that each of the disclosed techniques can be performed by a separate computing entity. The process will now be described with reference to the prospective prioritization computing entity 106 of the prospective prioritization system 101, as described above in relation to FIG. 1.

### Determining Prospective Qualifying Criteria Satisfaction Predictive Output

The process 400 begins at step/operation 401 when the prospective prioritization computing entity 106 determines for each predictive input entity of a plurality of predictive input entities, a prospective qualifying criteria satisfaction predictive output 612. A prospective qualifying criteria satisfaction predictive output 612 may refer to a data object indicating a likelihood describing a level of interest with respect to an event which triggers an interest with respect to a predictive input entity (e.g., the likelihood of coordination of benefits). A predictive input entity may refer to a data object that describes a member (e.g., a person) who receives healthcare services or products (or any other type of service or product) rendered by a provider and/or who relies on financing from a health insurance insurer (e.g., commercial health insurance company or government program such as Medicare and Medicaid) to cover the costs of the rendered health services or products. A member may be associated with the health insurance insurer and may be considered a member of (a program associated with) the health insurance insurer.

Coordination of benefits may refer to a scenario in which a member of one health insurance insurer (e.g., insurance company) has additional insurance coverage elsewhere. The additional coverage may be with another health insurance insurer (e.g., commercial health insurance company or government program such as Medicare, Medicaid, and the like). Generally, the primary insurance insurer (e.g., primary payer) in a coordination of benefits scenario is determined by a series of fixed rules. If a claim is submitted to one primary health insurance insurer for payment, but another health insurance insurer is determined to be the primary payer, the claim can be redirected to the other health insurance insurer. Moreover, some or all the cost of claims that may have been paid during a coverage overlap period can subsequently be reclaimed from the other health insurance insurer. Accordingly, coordination of benefits enables health insurance insurers to determine and/or identify the health insurance insurer that is the primary payer, so as to avoid duplicate payments and to ultimately reduce the cost of insurance premium for a member. In the noted coordination of benefits scenario, the prospective qualifying criteria satisfaction predictive output 612 may be a likelihood that a given member is eligible for insurance coverage through another health insurance insurer. For example, a member over the age of 65 may be eligible for Medicare and thus more likely to have additional coverage. As another example, a member that is married may be more likely to have additional insurance coverage. As yet another example, a child of two working parents may be more likely to have additional commercial insurance coverage.

In some embodiments, determining, by the prospective prioritization computing entity 106, a prospective qualifying criteria satisfaction predictive output 612 (e.g., the likelihood of coordination of benefits) for a predictive input entity of a plurality of predictive input entities include: (i) determining a predictive input channel (of a plurality of input channels) associated with the predictive input entity; (ii) determining a model of a plurality of models (e.g., supervised machine learning model) based at least in part on the predictive input channel; and (iii) determining the prospective qualifying criteria satisfaction predictive output 612 for the predictive input entity based at least in part on utilizing the determined model.

### Determining Predictive Input Channel in Relation to Prospective Qualifying Criteria Satisfaction Predictive Output

Each predictive input channel may refer to an inventory of data objects describing and/or corresponding with a plurality of predictive input entities. Each data object may store and/or represent feature data associated with a predictive input entity. In some embodiments, predictive input entities may be associated with a claim filing event for a member and an example data object may store claim features. Example claim features may include a claim ID and the date a claim was received—e.g., Dec. 14, 2021, at 12:00:00 μm and time stamped as 2021 Dec. 14 12:000:00. The claim features may also include one or more diagnostic codes, treatment codes, treatment modifier codes, and/or the like. Such codes may be any code, such as Current Procedural Terminology (CPT) codes, billing codes, Healthcare Common Procedure Coding System (HCPCS) codes, ICD-10-CM Medical Diagnosis Codes, and/or the like. In some embodiments, each predictive input channel may be associated with a probabilistic model or one or more deterministic rules. Additionally, the inventory generated therein may be generated in real-time such that the probabilistic models or deterministic rules are applied responsive to events which trigger an interest with respect to a predictive input entity (e.g., real-time events, triggering event occurrences, and/or the like). In other embodiments, the inventory may be generated prospectively by applying probabilistic models or deterministic rules in a continuous fashion (e.g., based at least in part on historical triggering event data). A predictive input channel may be configured to determine (e.g., prioritize, classify, select, organize, arrange, and/or the like) predictive input entities based at least in part on feature data.

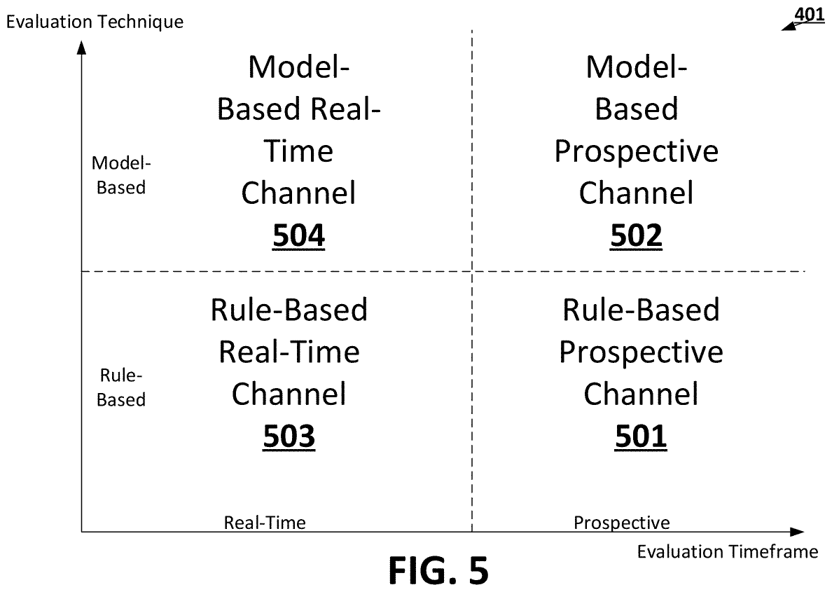

FIG. 5 illustrates a two-dimensional organizational diagram illustrating various characteristics of exemplary predictive input channels. Each channel may correspond with a different evaluation technique, illustrated on the y-axis of the diagram, and a different evaluation timeframe, illustrated on the x-axis of the diagram. As shown, the prospective prioritization computing entity 106 can determine one of four types of predictive input channels: a rule-based prospective channel 501, a model-based prospective channel 502, a rule-based real-time channel 503, and a model-based real-time channel 504.

A rule-based prospective channel 501 may correspond with a prospective evaluation timeframe and a rule-based evaluation technique. The rule-based prospective channel 501 may refer to a predictive input channel in which inventory is generated by applying one or more deterministic rules to a plurality of predictive input entities. For example, the deterministic rules may correspond with characteristics that may be present or absent in the feature data (e.g., member information/data) associated with a predictive input entity.

A model-based prospective channel 502 may correspond with a prospective evaluation timeframe and a model-based evaluation technique. The model-based prospective channel 502 may refer to a predictive input channel in which inventory is generated based at least in part on a probabilistic model that may be trained on historic data associated with a plurality of predictive input entities. For example, the inventory of the model-based prospective channel 502 may be generated based at least in part on historical information/data associated with a plurality of predictive input entities.

A rule-based real-time channel 503 may correspond with a real-time evaluation timeframe and a rule-based evaluation technique. The rule-based real-time channel 503 may also refer to a predictive input channel in which inventory is generated by applying one or more deterministic rules to a plurality of predictive input entities. For example, the deterministic rules may correspond with characteristics that may be present or absent in the feature data (e.g., member information/data) associated with a predictive input entity. Additionally, the inventory of the rule-based real-time channel 503 may be generated in response to one or more events which trigger an interest with respect to a predictive input entity (e.g., real-time events, triggering event occurrences, and/or the like).

A model-based real-time channel 504 may correspond with a real-time evaluation timeframe and a model-based evaluation technique. The model-based real-time channel 504 may also refer to a predictive input channel in which inventory is generated based at least in part on a probabilistic model that may be trained on historic data associated with a plurality of predictive input entities. For example, the inventory of the model-based real-time channel 504 may be generated based at least in part on historical information/data associated with a plurality of predictive input entities. Additionally, the inventory of the model-based real-time channel 504 may be generated in response to one or more events which trigger an interest with respect to a predictive input entity (e.g., real-time events, triggering event occurrences, and/or the like).

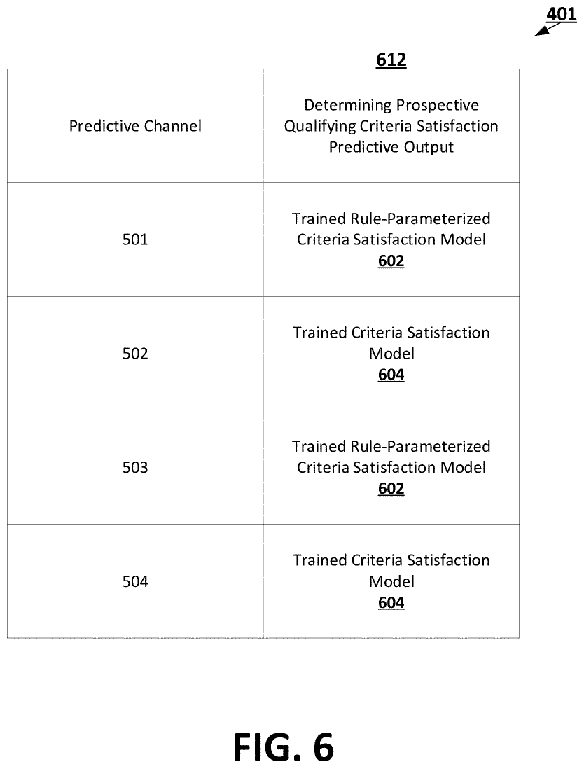

As noted above, the prospective prioritization computing entity 106 may be configured to utilize one of a plurality of models to perform predictive tasks with respect to each predictive input entity to generate one or more predictive outputs (e.g. prospective qualifying criteria satisfaction predictive output 612) with respect to the predictive input entity. The designated model for a predictive task may correspond with the type of predictive input channel associated with the predictive input entity. Referring to FIG. 6, for each predictive input channel and for each corresponding predictive input entity, one of a plurality of corresponding models may be mapped to the predictive input channel for generating the prospective qualifying criteria satisfaction predictive output 612. As shown, each predictive input channel 501, 502, 503, 504 is designated a particular model to perform the predictive tasks in order to generate a prospective qualifying criteria satisfaction predictive output 612 with respect to each predictive input entity. The models may comprise supervised (e.g., trained) machine learning models (e.g., neural network machine learning models) configured to perform predictive tasks and generate prospective qualifying criteria satisfaction predictive output 612 with respect to a predictive input entity. An exemplary machine learning model may generate a prospective qualifying criteria satisfaction predictive output 612 based at least in part on a machine learning algorithm/hypothesis function trained on feature subsets which are correlations extracted from feature data (e.g., predictive input entity characteristic data or historical event data associated with a predictive input entity). The correlations may be used to determine weight values for one or more variables of the hypothesis function. The exemplary machine learning model may use machine learning algorithms such as support vector machines, linear regression, logistic regression, naïve Bayes classifiers, decision trees, and the like to determine one or more weight values for each variable of the hypothesis function.

The prospective prioritization computing entity 106 may aggregate one or more sets of training data to train each machine learning model. To train a supervised machine learning model, a training engine of the prospective prioritization computing entity 106 may select feature subsets from feature data corresponding with predictive input entities for the purposes of a training iteration. The training engine may then process the feature subsets to determine an inferred related subset. Thereafter, the training engine may compare the inferred related subset to the feature subsets in order to generate an error function for the supervised machine learning model. The error function may indicate a difference between a feature subset (e.g., actual output extracted from the feature data) and an inferred related subset (e.g., predictive output generated by the machine learning model). The supervised machine learning model may optimize the one or more weight values of the hypothesis function in order to optimize for predictions with the smallest measure of error between the feature subsets and the inferred related subset. The prospective prioritization computing entity 106 may run one or more training iterations in order to update the one or more weight values to optimize the measure of error. Various types of supervised machine learning models and training algorithms may be used, such as a gradient descent training algorithm.

A rule-based prospective channel 501 or a rule-based real-time channel 503 may use a trained rule-parameterized criteria satisfaction model 602 to determine the prospective qualifying criteria satisfaction predictive output 612 (e.g., likelihood of coordination of benefits) based at least in part on feature data (e.g., demographic data) associated with the predictive input entities (e.g., age, state of residence, marital status, employment status, and the like). The trained rule-parameterized criteria satisfaction model 602 may be trained on the outcome of previous investigations where inventory is generated in accordance with one or more deterministic rules. Each deterministic rule corresponds with a baseline false positive rate, for example a deterministic rule may have a false positive rate of 80%. Thus, historic rule performance is the dominant feature in a trained rule-parameterized criteria satisfaction model 602. However, additional feature data (e.g., member information/data) may be used to improve the predictive outputs of the model.

### Performing Predictive Tasks in Relation to Prospective Qualifying Criteria Satisfaction Predictive Output

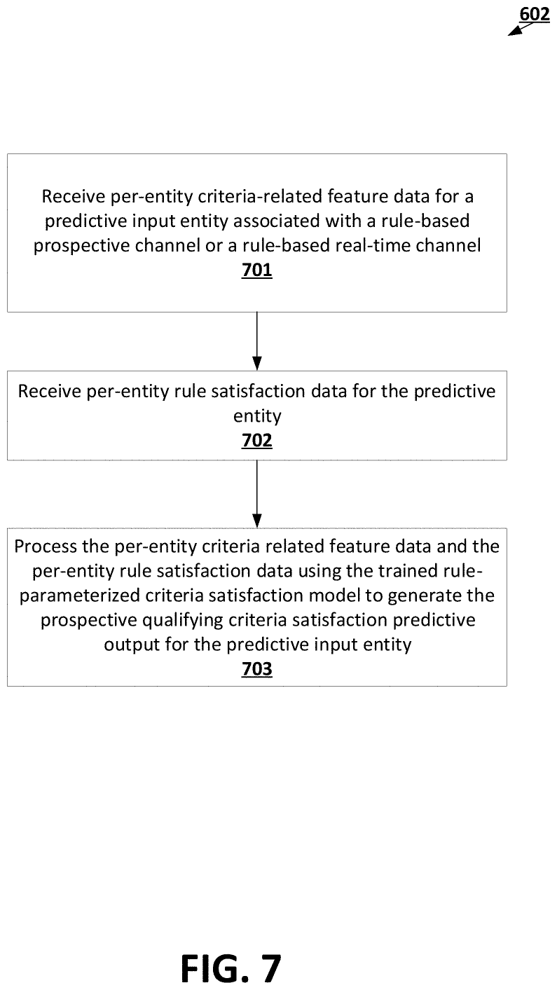

In some embodiments, as illustrated in FIG. 7, the prospective prioritization computing entity 106 may utilize a trained rule-parameterized criteria satisfaction model 602 to determine a prospective qualifying criteria satisfaction predictive output 612 with respect to a predictive input entity associated with a rule-based prospective channel 501 or a rule-based real-time channel 503. The trained rule-parameterized criteria satisfaction model 602 may be a supervised machine learning model (e.g., a neural network machine learning model). The supervised machine learning model may utilize machine learning algorithms such as support vector machines, linear regression, logistic regression, naïve Bayes classifiers, decision trees and the like.

FIG. 7 provides a flowchart diagram of an example process for a trained rule-parameterized criteria satisfaction model 602. Beginning at step/operation 701, the prospective prioritization computing entity 106 receives per-entity criteria-related feature data for a predictive input entity associated with a rule-based prospective channel 501 or a rule-based real-time channel 503. Per-entity criteria-related feature data may refer to feature data associated with a predictive input entity which satisfies one or more rules/model parameters. The model parameters may include one or more rule effectiveness parameters, whereby parameters are weighted based at least in part on their previous performance. A rule effectiveness parameter may refer to the likelihood that a data object is indicative of a true positive or a false positive, based at least in part on previous performance of the rule. Criteria-related feature data may comprise feature data and/or demographic data (e.g., age, gender, employment status, known health conditions, home location, profession medical history, claim history, member identifier, and/or the like).

At step/operation 702, the prospective prioritization computing entity 106 receives per-entity rule satisfaction data for the predictive input entity. Rule satisfaction data may refer to one or more rules associated with a high likelihood of a true positive based at least in part on previous performance of the one or more rules.

At step/operation 703, the prospective prioritization computing entity 106 processes the per-entity criteria-related feature data and the per-entity rule satisfaction data using the trained rule-parameterized criteria satisfaction model 602 to generate the prospective qualifying criteria satisfaction predictive output 612.

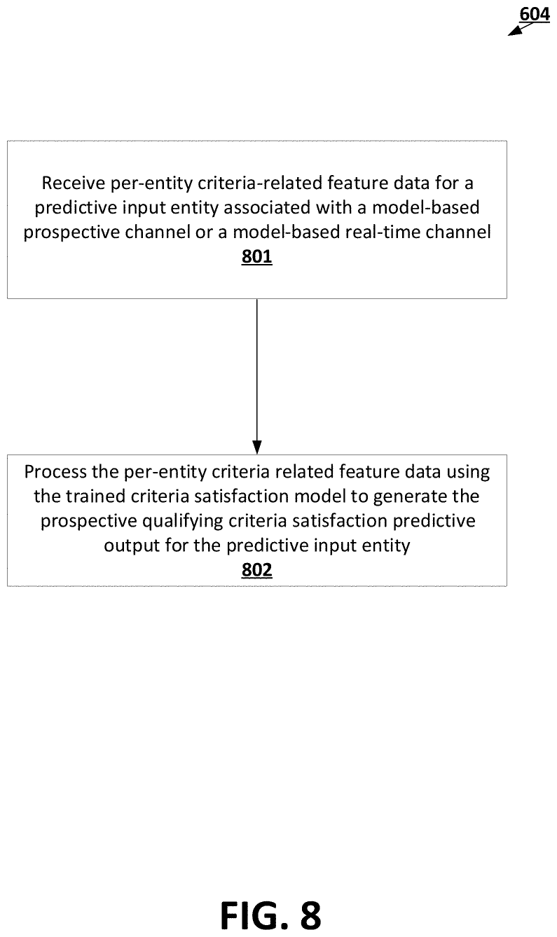

In some embodiments, as illustrated in FIG. 8, the prospective prioritization computing entity 106 may utilize a trained criteria satisfaction model 604 to determine a prospective qualifying criteria satisfaction predictive output 612 with respect to a predictive input entity associated with a model-based prospective channel 502 or a model-based real-time channel 504. The trained criteria satisfaction model 604 may be a supervised machine learning model (e.g., a neural network machine learning model). The supervised machine learning model may utilize machine learning algorithms such as support vector machines, linear regression, logistic regression, naïve Bayes classifiers, decision trees, and the like.

FIG. 8 provides a flowchart diagram of an example process for a trained criteria satisfaction model 604. Beginning at step/operation 801, the prospective prioritization computing entity 106 receives per-entity criteria-related feature data for a predictive input entity associated with a model-based prospective channel 502 or a model-based real-time channel 504. As described above in relation to the trained rule-parameterized criteria satisfaction model 602, per-entity criteria-related feature data may refer to feature data associated with a predictive input entity which satisfies one or more rules/model parameters. Criteria-related feature data may include feature data and/or demographic data (e.g., age, gender, employment status, known health conditions, home location, profession medical history, claim history, member identifier, and/or the like).

At step/operation 802, the prospective prioritization computing entity 106 processes the per-entity criteria-related feature data using the trained criteria satisfaction model 604 to determine the prospective qualifying criteria satisfaction predictive output 612.

### Determining Prospective Triggering Event Occurrence Predictive Output

Returning to FIG. 4 at step/operation 402, the prospective prioritization computing entity 106 determines for each predictive input entity of a plurality of predictive input entities, a prospective triggering event occurrence predictive output 611. The prospective triggering event occurrence predictive output 611 may refer to a data object indicating a likelihood of an event which triggers an interest with respect to a predictive input entity (e.g., the likelihood of claim filing/likelihood of high-value claim filing). As described above, a predictive input entity may refer to a data object that describes a member (e.g., a person) who receives healthcare services or products (or any other type of service or product) rendered by a provider and/or who relies on financing from a health insurance insurer (e.g., commercial health insurance company or government program such as Medicare and Medicaid) to cover the costs of the rendered health services or products. Moreover, predictive input entities may be associated with a claim filing for a member and an example data object may store claim features, as described above.

In some embodiments, the prospective triggering event occurrence predictive output 611 may be a likelihood that a given member will file a claim during a predefined period (e.g., next 3 months, next 6 months, and/or the like). In some embodiments, the prospective triggering event occurrence predictive output 611 may be a likelihood that a given member will file a high-value claim (further described below), during a predefined period (e.g., next 3 months, next 6 months, and/or the like). A claim may describe a request for payment/reimbursement for services rendered, materials used, equipment provided, and/or the like. For example, a claim may be a request for payment/reimbursement for a consultation with a primary care doctor, a medical procedure or an evaluation performed by a laboratory, a surgery, durable medical equipment provided to an injured patient, medications or other materials used in the treatment of a patient, and/or the like.

In some embodiments, determining, by the prospective prioritization computing entity 106, a prospective triggering event occurrence predictive output 611 (e.g., likelihood of claim filing/likelihood of high-value claim filing) for each predictive input entity of a plurality of predictive input entities includes: (i) determining, a predictive input channel (of a plurality of input channels) associated with the predictive input entity; (ii) determining a model of a plurality of models (e.g., supervised machine learning model) based at least in part on the predictive input channel; and (iii) determining the prospective triggering event occurrence predictive output 611 for the predictive input entity based at least in part on utilizing the determined model.

### Determining Predictive Input Channel in Relation to Prospective Triggering Event Occurrence Predictive Output

As described above and as shown in FIG. 5, the prospective prioritization computing entity 106 can determine one of four types of predictive input channels: a rule-based prospective channel 501, a model-based prospective channel 502, a rule-based real-time channel 503, and a model-based real-time channel 504. Moreover, each input channel may correspond with a different evaluation technique. In some embodiments, each predictive input channel may be designated a particular model to perform predictive tasks in order to generate a prospective triggering event occurrence predictive output 611 with respect to a predictive input entity.

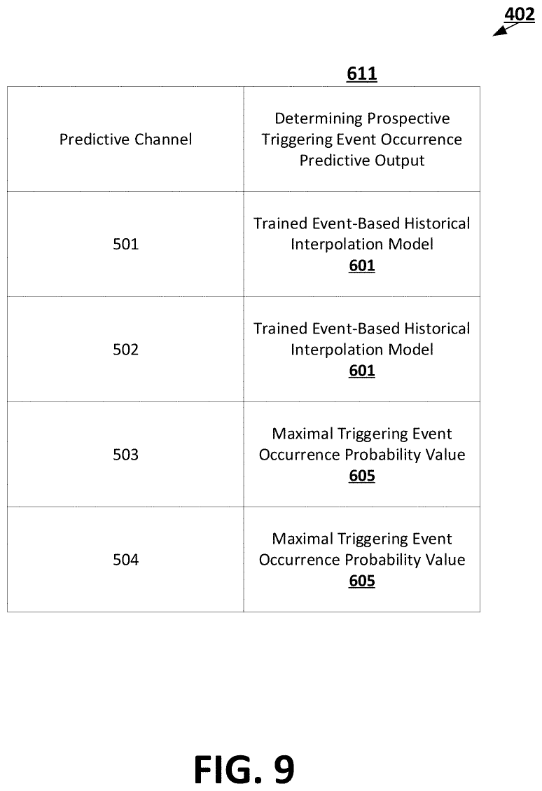

As noted above, the prospective prioritization computing entity 106 may be configured to utilize one of a plurality of models to perform predictive tasks to generate one or more predictive outputs (e.g., prospective triggering event occurrence predictive output 611) with respect to a predictive input entity. The designated model for a predictive task may correspond with the type of predictive input channel associated with the predictive input entity. Referring to FIG. 9, for each predictive input channel and for each corresponding predictive input entity, one of a plurality of corresponding models may be mapped to the predictive input channel for generating the prospective triggering event occurrence predictive output 611. As shown, each predictive input channel 501, 502, 503, 504 is designated a particular model to perform the predictive tasks in order to generate a prospective triggering event occurrence predictive output 611 with respect to each predictive input entity. The models may comprise supervised (e.g., trained) machine learning models (e.g., neural network machine learning models, binary classification models, or the like) configured to perform predictive tasks and generate a prospective triggering event occurrence predictive output 611 with respect to a predictive input entity. An exemplary machine learning model may generate a prospective triggering event occurrence predictive output 611 based at least in part on a machine learning algorithm/hypothesis function trained on feature subsets which are correlations extracted from feature data (e.g., predictive input entity characteristic data or historical event data associated with a predictive input entity). The correlations may be used to determine weight values for one or more variables of the hypothesis function. The exemplary machine learning model may use machine learning algorithms such as support vector machines, linear regression, logistic regression, naïve Bayes classifiers, decision trees, and the like to determine one or more weight values for each variable of the hypothesis function.

The prospective prioritization computing entity 106 may aggregate one or more sets of training data to train the machine learning model. As described above, to train a supervised machine learning model, a training engine of the prospective prioritization computing entity 106 may select feature subsets from feature data corresponding with predictive input entities for the purposes of a training iteration. The training engine may then process the feature subsets to determine an inferred related subset. Thereafter, the training engine may compare the inferred related subset to the feature subsets in order to generate an error function for the supervised machine learning model. The error function may indicate a difference between a feature subset (i.e., actual output extracted from the feature data) and an inferred related subset (i.e., predictive output generated by the machine learning model). The supervised machine learning model may optimize the one or more weight values of the hypothesis function in order to optimize for predictions with the smallest measure of error between the feature subsets and the inferred related subset. The prospective prioritization computing entity 106 may run one or more training iterations in order to update the one or more weight values to optimize the measure of error. Various types of supervised machine learning models and training algorithms may be used, such as a gradient descent training algorithm.

### Performing Predictive Tasks in Relation to Prospective Triggering Event Occurrence Predictive Output

As shown in FIG. 9, in some embodiments, the prospective prioritization computing entity 106 may use a maximal triggering event occurrence probability value 605 to determine a prospective triggering event occurrence predictive output 611 with respect to a predictive input entity associated with a rule-based real-time channel 503 or a model-based real-time channel 504. With respect to a real-time channel 503, 504, the maximal triggering event occurrence probability value 605 may be a numeric value corresponding with a triggering event occurrence. For example, the maximal triggering event occurrence probability value 605 may be deemed absolute/certain (e.g., “1”) in the event of a triggering event occurrence.

In some embodiments, as illustrated in FIG. 9, the prospective prioritization computing entity 106 may utilize a trained event-based historical interpolation model 601 to determine a prospective triggering event occurrence predictive output 611 with respect to a predictive input entity associated with a rule-based prospective channel 501 or a model-based prospective channel 502. For example, a trained event-based historical interpolation model 601 may be used to determine the prospective triggering event occurrence predictive output 611 based at least in part on historical triggering event data (e.g., medical history/claim features) associated with the predictive input entity (e.g., number of claims, dates of claims, disease profile history, and the like). Example claim features may include the date a claim was received (e.g., Dec. 14, 2021, at 12:00:00 μm and time stamped as 2021 Dec. 14 12:00:00). The claim features may also include one or more diagnostic codes, treatment codes, treatment modifier codes, and/or the like. Such codes may be any code, such as Current Procedural Terminology (CPT) codes, billing codes, Healthcare Common Procedure Coding System (HCPCS) codes, ICD-10-CM Medical Diagnosis Codes, and/or the like. The trained event-based historical interpolation model may be a supervised machine learning model (e.g., a neural network machine learning model, binary classification model, or the like). The supervised machine learning model may utilize machine learning algorithms such as support vector machines, linear regression, logistic regression, naïve Bayes classifiers, decision trees, and the like.

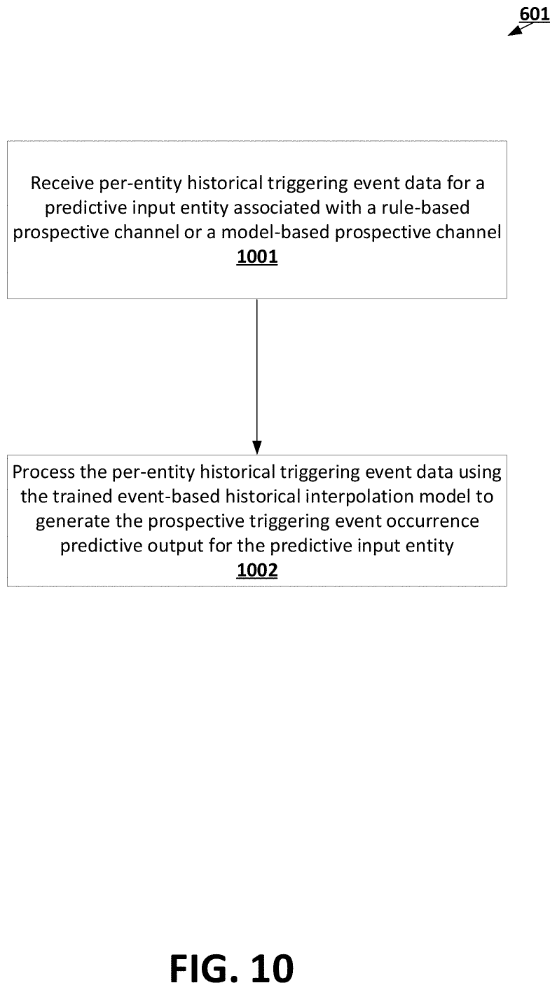

FIG. 10 provides a flowchart diagram of an example process for a trained event-based historical interpolation model 601 in accordance with some embodiments. Beginning at step/operation 1001, the prospective prioritization computing entity 106 receives per-entity historical triggering event data associated with a predictive input entity associated with a rule-based prospective channel 501 or model-based prospective channel 502. Per-entity historical triggering event data may refer to feature data associated with a predictive input entity which corresponds with previous triggering event occurrences with respect to the predictive input entity and may include an indication of a frequency of the previous triggering event occurrences and/or characteristics corresponding with the frequency of previous triggering event occurrences.

At step/operation 1002, prospective prioritization computing entity 106 processes the per-entity historical triggering event data to generate the prospective triggering event occurrence predictive output 611 with respect to the predictive input entity. For example, the trained event-based historical interpolation model 601 may utilize a trained machine learning algorithm, trained on historical triggering event data feature subsets to generate the prospective triggering event occurrence predictive output 611. In some embodiments, the historical triggering event data may comprise claim data and/or member information/data corresponding with the likelihood of the prospective triggering event occurrence. Claim data may include doctor visits, hospital stays, and/or the like. Member information/data may include disease profiles, chronic conditions, and/or the like.

### Prospective Prediction Machine Learning Model

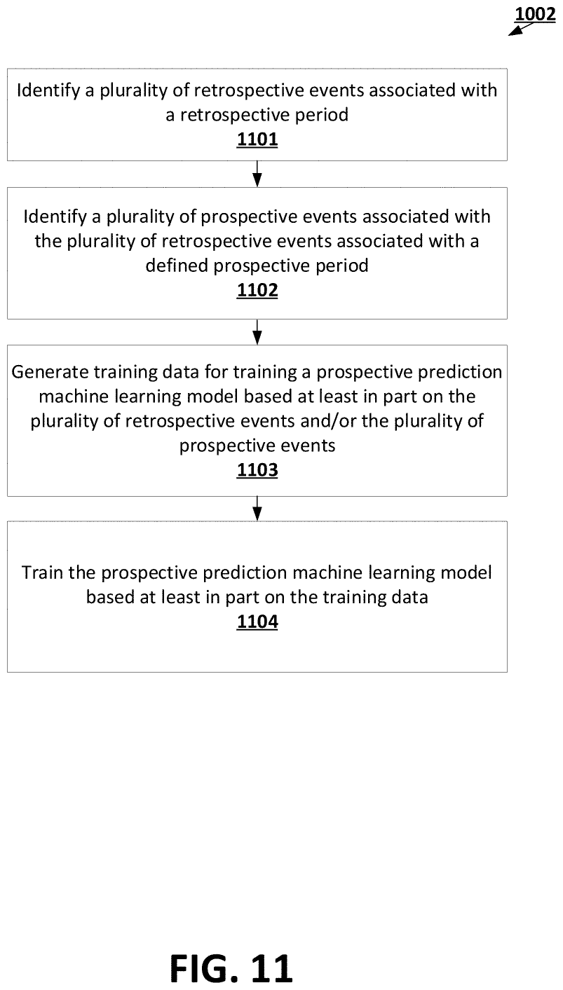

As noted above, in some embodiments, the trained event-based historical interpolation model 601 may be used to determine the prospective triggering event occurrence predictive output 611 based at least in part on historical triggering event data (e.g., medical history/claim features) associated with the predictive input entity (e.g., claims history, number of claims, dates of claims, disease profile history, and the like). In some embodiments, the trained event-based historical interpolation model may utilize binary classification. FIG. 11 is a process flow chart for training a prospective prediction machine learning model (e.g., a trained event-based historical interpolation model) in accordance with some embodiments.

The process depicted in FIG. 11 begins at step/operation 1101 when the prospective prioritization computing entity 106 identifies a plurality of retrospective events associated with a retrospective period with respect to each training input entity, where: (i) each retrospective event of the plurality of retrospective events is associated with a training input entity of the plurality of training input entities, and (ii) each training input entity is associated with a prediction date according to which a retrospective period for the respective training input entity and a prospective period for the respective training input entity are inferred.

A retrospective period may describe a timeframe before the prediction date associated with a respective training input entity. For example, a retrospective period for a respective training input entity includes the timeframe starting at m months (e.g., twelve-months, twenty four-months, or the like) prior to a prediction date for the respective training input entity and continuing until the noted prediction date. For each training input entity, the corresponding retrospective period is associated with a prospective period, where a prospective period may describe a timeframe after the prediction date associated with the training input entity. For example, a prospective period for a respective training input entity includes the timeframe starting at the prediction date for the training input entity and continuing until p months (e.g., three months, six months, or the like) after the prediction date, where the prediction time window can be p number of months. In some embodiments, the prediction date for each training input entity may be the same. In some embodiments, the prediction date for one or more of the training input entities may be different.

Retrospective event may refer to data object that describes a prospective triggering event occurrence (e.g., an event which triggers an interest with respect to a predictive input entity) that is associated with a retrospective period. In some example embodiments, the data object may describe a request for payment/reimbursement for service rendered, materials used, equipment provided, and/or the like (e.g., claim filing) that occurred during a retrospective period. In some embodiments, each retrospective event may be associated with corresponding per-entity historical triggering event data (e.g., claim data and/or member information/data). For example, the per-entity historical triggering event data associated with a particular training input entity may include an event valuation (e.g., claim spend/amount) for a corresponding retrospective event.

At step/operation 1102, the prospective prioritization computing entity 106 identifies a plurality of prospective events associated with the plurality of retrospective events and associated with a defined prospective period (e.g., the event occurred during the prospective period), where each prospective event is associated with an event valuation (e.g., claim spend/amount). As noted above, a prospective period may describe a timeframe after a prediction date associated with a respective training input entity (e.g., p subsequent months, where p may be configurable for a given application).

### Generating Training Data for a Prospective Prediction Machine Learning Model

At step/operation 1103, the prospective prioritization computing entity 106 generates training data for training the prospective prediction machine learning model, where training data is characterized by input properties along with periodic ground-truth values (further described below) with respect to the training input entities. In some embodiments, the prospective prioritization computing entity 106 generates the training data based at least in part on the plurality of retrospective events and/or the plurality of prospective events. In some embodiments, generating training data for training the prospective prediction machine learning model includes: (i) for each training input entity, identifying feature data associated with one or more retrospective events; (ii) for each training input entity, aggregating (e.g., all or portions of) the feature data; and (iii) for each training input entity, generating based at least in part on the aggregated data, input properties (e.g., number of claims submitted during a defined period, claim spend during a defined period, hospital visit occurrence during a defined period, frequency of hospital visits during a defined period, demographic information of the training input entity, and/or the like, where the defined period may be the retrospective period for the corresponding training input entity) along with a periodic ground-truth value, for training the prospective prediction machine learning model. For example, during training, each training input entity is classified (e.g., classified as filed a claim or not filed a claim during the corresponding prospective period, classified as filed a high-value claim or not filed a high-value claim during the corresponding prospective period, and/or the like) based at least in part on the periodic ground truth-value.

In some embodiments, the prospective prioritization computing entity 106 may be configured for generating training data that may be used to train the prospective prediction machine learning model to predict the probability that a predictive input entity (e.g., a member) will file one or more claims within a defined timeframe (e.g., three months, six months, and/or the like). In such embodiments, a periodic ground-truth value may be a value (e.g., zero, one, five, and/or the like) that describes the occurrence of one or more prospective events or no occurrence of prospective events with respect to a training input entity (e.g., within the prospective period). For example, a periodic ground-truth value of “one” may describe the occurrence of one or more prospective events (e.g., claim filing) with respect to a training input entity and a periodic ground-truth value of “zero” may describe no occurrence of prospective events (e.g., claim filing) with respect to a training input entity.

In some embodiments, the prospective prioritization computing entity 106 may be configured to generate training data that may be used to train the prospective prediction machine learning model to predict the probability that a member will file one or more claims within a defined timeframe (e.g., three months, six months, and/or the like) with a respective total claim spend/amount that is considered high-value (e.g., high-value claim). In such embodiments, a periodic ground-truth value may be a value (e.g., zero, one, five, and/or the like) that describes the occurrence of one or more prospective events (e.g., claim filing) that satisfies a threshold measure or no occurrence of prospective events that satisfies the threshold measure with respect to a training input entity. For example, a periodic ground-truth value of “one” may describe the occurrence of one or more prospective events with respect to a training input entity where the total event valuation of the one or more prospective events satisfies a threshold measure and a periodic ground-truth value of “zero” may describe no occurrence of prospective events (with respect to a training input entity) where the total event valuation (if any) satisfies the threshold measure.

In some embodiments, prospective prioritization computing entity 106 may be configured to generate a valuation distribution data object, where the threshold measure is based at least in part on the valuation distribution data object and where the valuation distribution data object describes a distribution (e.g., statistical distribution) of the total event valuation for each training input entity associated with the plurality of prospective events. The valuation distribution data object may comprise one or more percentiles (e.g., 5^{th} percentile, 10^{th} percentile, and/or the like). In such example embodiments, the threshold measure may be one of the one or more percentiles of the valuation distribution data object (e.g., top 5 percent, top 10 percent, or the like). For example in some embodiments, a periodic ground-truth value of “one” may describe the probability of the occurrence of claim filing with respect to a training input entity whose total claim spend/amount in the prospective period is in the 5^{th} percentile (or higher) of the valuation distribution of the plurality of prospective events, while a periodic ground-truth value of “zero” may describe otherwise (e.g. below the 5^{th} percentile).

In some embodiments, the threshold measure may be a decile value (e.g., based at least in part on the total event valuation for each training input entity). In some embodiments, the threshold measure may be a monetary amount. For example, in some embodiments, a periodic ground-truth value may describe the occurrence of claim filing (with respect to a training input entity) whose total event valuation (e.g., total claim spend/amount) is at least X amount (e.g., $23,000, $1000, and/or the like) or no occurrence of claim filing (with respect to a training input entity) whose total event valuation (e.g., total claim spend/amount) is at least X amount (e.g., $23,000, $1000, and/or the like). In some other example embodiments, a periodic ground-truth value may describe the occurrence of claim filing (with respect to a training input entity) whose total event valuation (e.g., total claim spend/amount) is more than X amount (e.g., $23,000, $1000, and/or the like) or no occurrence of claim filing (with respect to a training input entity) whose total event valuation (e.g., total claim spend/amount) is more than X amount (e.g., $23,000, $1000, and/or the like). In some embodiments, to determine the threshold measure, the prospective prioritization computing entity 106 may be configured to: (i) for each training input entity, aggregate each event valuation of the plurality of prospective events associated with the training input entity to determine a total event valuation for the training input entity, and/or (ii) generate a valuation distribution data object (as describe above) based at least in part on the total event valuations.

In some embodiments, the ground-truth event label may be a continuous target variable. For example, in some embodiments, the ground-truth event label itself may be a monetary value (e.g., $20,000, $500, or the like). For example, the prospective prioritization computing entity may be configured to determine/generate, for each training input entity, a prediction of the total event valuation (e.g., total claim spend/amount) for a training input entity during the prospective period based at least in part on historical data (e.g., past claim history and claim spend/amount).

In some embodiments, for each training input entity, the prospective prioritization computing entity 106 extracts feature data from historical data associated with each retrospective event associated with a respective training input entity. Feature data may include historical triggering event data corresponding with the likelihood of prospective triggering event occurrence (e.g., claim filing/high-value claim filing), where the historical triggering event data may include claim data and/or member information data. For example, claim data may describe a number of or frequency of historical triggering event occurrences (e.g., claims submitted, doctor visits, hospital stays, and/or the like). In some embodiments, the prospective prioritization computing entity aggregates the feature data based at least in part on a unique identifier (e.g., member identifier) associated with the retrospective event. For example, in some embodiments, feature data is grouped by training input entity (e.g., based at least in part on the member identifier) and corresponding data is aggregated to generate input properties for the prospective prediction machine learning model.

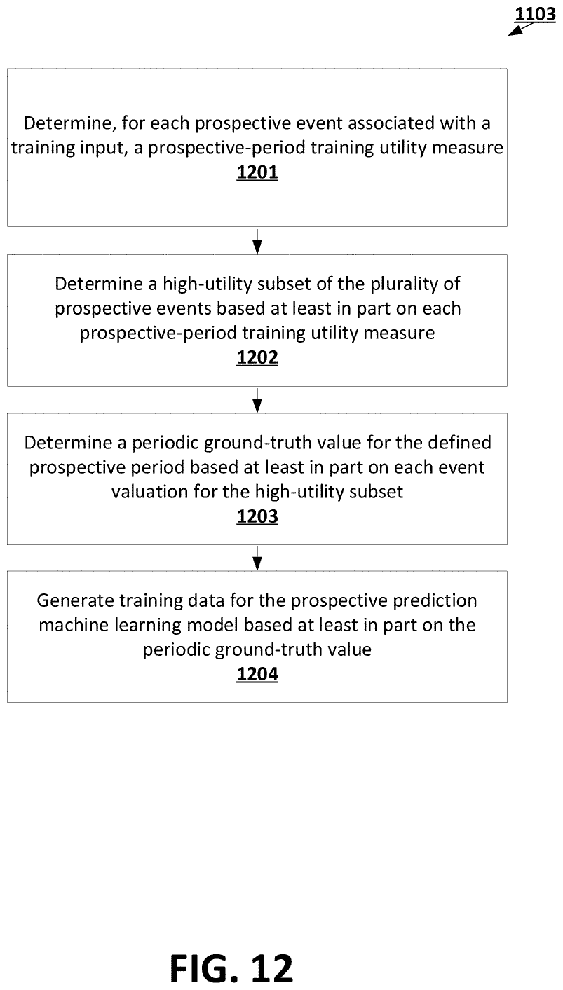

In some embodiments, as illustrated in FIG. 12, the prospective prioritization computing entity may generate training data for the prospective prediction machine learning model based at least in part on a subset of the plurality of retrospective events and/or a subset of the plurality of prospective events. In such embodiments, the prospective prioritization computing entity may identify feature data based at least in part on the subset of the plurality of retrospective events and/or the subset of the plurality of prospective events.

FIG. 12, provides an example flowchart diagram for generating training data for a prospective prediction machine learning model. The process that is depicted in FIG. 12 begins at step/operation 1201 when the prospective prioritization computing entity 106 determines for each prospective event of the plurality of prospective events, a prospective-period training utility measure. A prospective-period training utility measure may describe an estimated/predicted utility of training a prospective prediction machine learning model using a corresponding prospective event. In some embodiments, the prospective prioritization computing entity 106 determines a prospective-period utility measure for a prospective event based at least in part on the event valuation for the prospective event. In some example embodiments, to determine prospective-period training utility measure for a given prospective event, the prospective prioritization computing entity 106 determines whether the prospective event satisfies a predefined measure (e.g., monetary amount, medical visit type, claim type, and/or the like), where prospective events that satisfy the predefined measure are deemed high-utility and prospective events that do not satisfy the predefined measure are deemed low-utility.

As an example, the prospective prioritization computing entity 106 may be configured to determine whether event valuation for each prospective event is above a predefined monetary amount (e.g., $1000, $7,000, and/or the like), where prospective events with event valuation above the predefined monetary amount are deemed high-utility and prospective events with event valuation below the predefined monetary amount are deemed low-utility. As another example, the prospective prioritization computing entity 106 may be configured to determine whether a prospective event is associated with a routine medical visit (e.g., flu vaccination, periodic medical check-up, and/or the like), where prospective events associated with routine medical visits are deemed low-utility and prospective events not associated with routine medical visits are deemed high-utility.

Additionally, in some embodiments, the prospective prioritization computing entity 106 may determine for each retrospective event associated with a training input entity, a retrospective-period training utility measure. Retrospective-period training utility measure may describe an estimated/predicted utility of training a prospective prediction machine learning model using a corresponding retrospective event. In some embodiments, the prospective prioritization computing entity 106 determines a retrospective-period training utility measure for a retrospective event based at least in part on the event valuation for the retrospective event. In some example embodiments, to determine retrospective-period training utility measure for a given retrospective event, the prospective prioritization computing entity 106 determines whether the retrospective event satisfies a predefined measure (e.g., monetary amount, medical visit type, claim type, and/or the like), where retrospective events that satisfy the predefined measure are deemed high-utility and retrospective events that do not satisfy the predefined measure are deemed low-utility.

As an example, the prospective prioritization computing entity 106 may be configured to determine whether event valuation for each retrospective event is above a predefined monetary amount (e.g., $1000, $3,000, and/or the like), where retrospective events with event valuation above the predefined monetary amount are deemed high-utility and retrospective events with event valuation below the predefined monetary amount are deemed low-utility. As another example, the prospective prioritization computing entity 106 may be configured to determine whether a retrospective event is associated with a routine medical visit (e.g., flu vaccination, periodic medical check-up, and/or the like), where retrospective events associated with routine medical visits are deemed low-utility and retrospective events not associated with routine medical visits are deemed high-utility.

At step/operation 1202, the prospective prioritization computing entity 106 determines a high-utility subset of the plurality of prospective events based at least in part on the prospective-period training utility measure. In some embodiments, to determine a high-utility subset of the plurality of prospective events, the prospective prioritization computing entity 106 excludes/filters from the plurality of prospective events, prospective events deemed low-utility (e.g., events associated with low-value claims, routine medical visits, and/or the like). Additionally, in some embodiments, the prospective prioritization computing entity may determine a high-utility subset of the plurality of retrospective events based at least in part on each retrospective-period training utility measure. In some embodiments, to determine a high-utility subset of the plurality of retrospective events, the prospective prioritization computing entity 106 excludes/removes from the plurality of retrospective events, retrospective events (thus, associated feature data) deemed low-utility (e.g., events associated with low-value claims, routine medical visits, and/or the like).

At step/operation 1203, the prospective prioritization computing entity 106 determines a periodic ground-truth value for the defined prospective period with respect to each training input. In some embodiments, the prospective prioritization computing entity 106 determines the periodic ground-truth value for the defined prospective period with respect to each training input based at least in part on the high utility subset of the plurality of prospective events. In such embodiments, the periodic ground-truth value may be a value (e.g., zero, one, five, and/or the like) that describes the occurrence of one or more prospective events of the high-utility subset with respect to a training input entity or no occurrence of prospective events of the high-utility subset with respect to a training input entity. For example, a periodic ground-truth value of “one” may describe the occurrence of one or more prospective events of the high-utility subset with respect to a training input entity and a periodic ground-truth value of “zero” may describe no occurrence of prospective events of the high-utility subset with respect to a training input entity.

In some other embodiments, the prospective prioritization computing entity 106 determines the periodic ground-truth value for the defined prospective period with respect to each training input entity based at least in part on each event valuation for the high-utility subset of the plurality of prospective events. In such embodiments, the periodic ground-truth value may describe a value (e.g., zero, one, five, and/or the like) that describes the occurrence of one or more prospective events of the high-utility subset with respect to a training input entity, where the total event valuation of the one or more prospective events satisfies a threshold measure or no occurrence of prospective events of the high-utility subset with respect to a training input entity, with a total event valuation (if any) that satisfies the threshold measure (e.g., the total event valuation (if any) does not satisfy the threshold measure). For example, a periodic ground-truth value of “one” may describe the occurrence of one or more prospective events of the high-utility subset with respect to a training input entity, where the total event valuation of the one or more prospective events satisfies a threshold measure and a periodic ground-truth value of “zero” may describe no occurrence of prospective events of the high-utility subset with respect to a training input entity, with total event valuation (if any) that satisfies the threshold measure.

In some embodiments, prospective prioritization computing entity 106 may be configured to generate a valuation distribution data object, where the threshold measure is based at least in part on the valuation distribution data object, and where the valuation distribution data object may describe a distribution (e.g., statistical distribution) of the total event valuation for each training input entity associated with the high-utility subset of the plurality of prospective events. The valuation distribution data object may comprise one or more percentiles (e.g., 5^{th} percentile, 10^{th} percentile, and/or the like). In such embodiments, the threshold measure may be one of the one or more percentiles of the valuation distribution of the high-utility subset (e.g., top 5 percent, top 10 percent, or the like). For example, a periodic ground-truth value of “one” may describe the probability of the occurrence of claim filing with respect to a training input entity whose total claim spend/amount in the prospective period is in the 5^{th} percentile (or the like) of the valuation distribution of the high utility subset.

In some embodiments, the threshold measure may be a decile value (e.g., based at least in part on the total event valuation with respect to each training input entity with respect to the high-utility subset). In some embodiments, the threshold measure may be a monetary amount. For example, in some embodiments, a periodic ground-truth value may describe the occurrence of claim filing with respect to a training input entity whose total event valuation (e.g., total claim spend/amount) is at least X amount (e.g., $43,000, $9000, and/or the like) or no occurrence of claim filing with respect to a training input entity whose total event valuation (e.g., total claim spend/amount) is at least X amount (e.g., $43,000, $9000, and/or the like). In some other example embodiments, a periodic ground-truth value may describe the probability of the occurrence of claim filing with respect to a training input entity whose total event valuation (e.g., total claim spend/amount) is more than X amount (e.g., $43,000, $9000, and/or the like) or no occurrence of claim filing with respect to a training input entity whose total event valuation (e.g., total claim spend/amount) is more than X amount (e.g., $43,000, $9000, and/or the like). In some embodiments, to determine the threshold measure, the prospective prioritization computing entity 106 may be configured to: (i) for each training input entity, aggregate each event valuation of the high-utility subset of the plurality of prospective events associated with the training input entity to determine a total event valuation for the training input entity, and/or (ii) generate a valuation distribution data object (as noted above) based at least in part on the total event valuations of the high-utility subset of the plurality of prospective events.

At step/operation 1204, the prospective prioritization computing entity 106 generates training data for the prospective prediction machine learning model based at least in part on the periodic ground-truth value. As noted above, in some embodiments, generating the training data includes extracting feature data from historic data (e.g., historical triggering event data) associated with the high-utility subset of retrospective events. In example embodiments, the prospective prioritization computing entity 106, for each training input entity: (i) identifies feature data associated with one or more retrospective events of the subset of retrospective events; (ii) aggregates (e.g., all or portions of) the feature data; and (iii) generates, based at least in part on the aggregated data, input properties (e.g., number of claims submitted during a defined period, claim spend during a defined period, hospital visit occurrence during a defined period, frequency of hospital visits during a defined period, demographic information of the training input entity, and/or the like) along with the ground-truth value (e.g., determined at step/operation 1203).

### Training a Prospective Prediction Machine Learning Model

Returning to FIG. 11, at step/operation 1104, the prospective prioritization computing entity 106 trains the prospective prediction machine learning model based at least in part on the training data generated in step/operation 1103. In some embodiments, each training input entity may be associated with a training data field of a plurality of training data fields. A training data field describes a data object that describes one or more input properties of a predictive entity along with one or more ground-truth event labels for the training input entity. A ground-truth event label for the training input entity may describe a periodic ground-truth value which describes whether a prospective event (e.g., claim filing/high-value claim filing within a specified prospective period) has occurred or has not occurred during the specified prospective period with respect to the training input entity. In some embodiments, a particular training data field may describe one or more input properties of a training input entity along with a ground-truth event label describing whether the training input entity has filed a claim during a specified prospective period or has not filed a claim during the specified prospective period. In some embodiments, a particular training data field may describe one or more input properties of a training input entity along with a ground-truth event label describing whether the training input entity has filed a high-value claim during a specified prospective period or has not filed a high-value claim during the specified prospective period. Additionally, each training data field may include metadata (e.g., member identifier, prediction date, and/or the like).

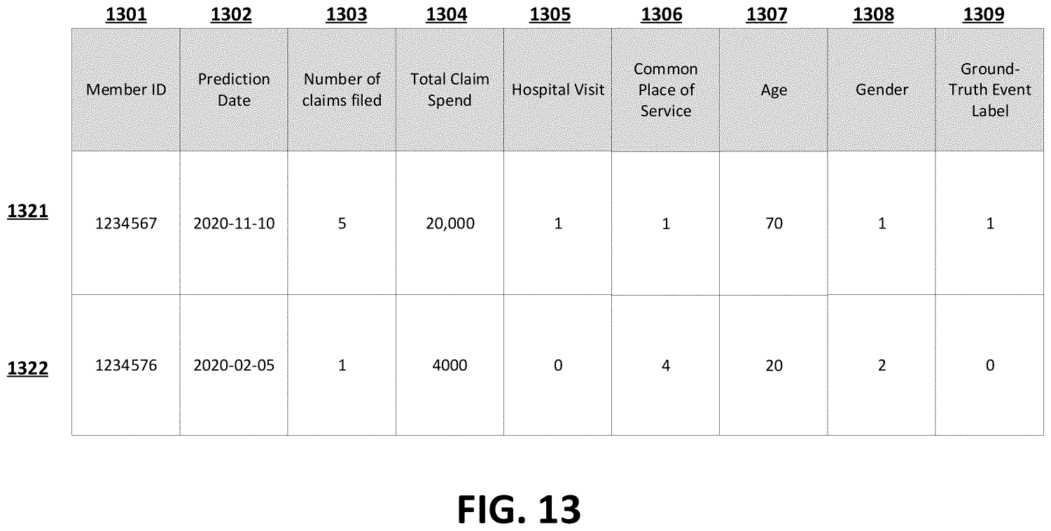

An operational example of training data fields 1321 and 1322 is presented in FIG. 13. As depicted in FIG. 13, each training data field may include a member identifier descriptor 1301 that describes a predictive input entity associated with the training data field, a prediction date descriptor 1302 according to which a retrospective period for the training data field and a prospective period for the training data field are inferred, a claim count descriptor (e.g., number of claims filed) 1303 that describes the number of claims filed by the corresponding training input during the retrospective period, total claim spend descriptor 1304 that describes the total claim spend/amount by the corresponding training input during the retrospective period, hospital visit descriptor 1305 that describes whether the corresponding training input entity had a hospital visit during the retrospective period, a common place of service descriptor 1306 that describes the most common place of service with respect to the corresponding training input entity, an age descriptor 1307 that describes the age associated with the corresponding training input entity during the retrospective period, a gender descriptor 1308 that describes the gender of the corresponding training input entity, a ground-truth event label descriptor 1309 that describes the periodic ground-truth value for the corresponding training input entity, where the a ground-truth value of “one” may describe that the corresponding training input entity was recorded to have filed a claim/high value claim during the prospective period for the training input entity and a ground-truth value of “zero” may describe that the corresponding training input entity was recorded to have not filed a claim/high-value claim during the prospective period for the training input entity.

In some embodiments, to train the prospective prediction machine learning model, a training engine of the prospective prioritization computing entity 106 may: (i) retrieve an output classification generated by the prospective prediction machine learning model for each training data field after processing; (ii) retrieve a ground-truth classification for the prediction input from the training data; (iii) compare the output classification and the ground-truth classification to generate an error measure/function for the prospective prediction machine learning model; and (iv) set the parameters of the machine learning model based at least in part on the error measure/function.

In some embodiments, a training engine of the prospective prediction machine learning model may select feature subsets from feature data corresponding with the training input entities for the purposes of training iteration. The training engine may then process the feature subsets to determine inferred related subset. Thereafter, the training engine may compare the inferred subset to the feature subset in order to generate an error function for the prospective prediction machine learning model, where the error function may indicate a difference between a feature subset (e.g., actual output extracted from the feature data) and an inferred related subset (e.g., predictive output generated by the prospective prediction machine learning model.

### Determining a Prospective Prioritization Score (Prospective Priority Score)

to FIG. 4, at step/operation 403, the prospective prioritization computing entity 106 determines a prospective priority score (e.g., prospective prioritization score) for each predictive input entity. The prospective priority score may be based at least in part on the predictive outputs of one or more predictive tasks. In some embodiments, the prospective priority score may be based at least in part on one or more of the prospective qualifying criteria satisfaction predictive output 612 and the prospective triggering event occurrence predictive output 611 determined at steps/operations 401 and 402. In some embodiments, an arithmetic ensemble model aggregating the prospective qualifying criteria satisfaction predictive output 612 and the prospective triggering event occurrence predictive output 611 may be utilized to generate the prospective priority score. In some embodiments, one or more of the prospective qualifying criteria satisfaction predictive output 612 and the prospective triggering event occurrence predictive output 611 may be substituted with static averages.

In some embodiments, determining the prospective priority score may include performing the operation described by the below equation:

S=P1*P2 Equation 1

In equation 1:
S is the prospective priority score for a predictive input entity,
P1 is the prospective qualifying criteria satisfaction predictive output for the predictive input entity (e.g., likelihood of coordination of benefits), and
P2 is the prospective triggering event occurrence predictive output for the predictive input entity (likelihood of claim filing/likelihood of high-value claim filing).

In an example embodiment, the arithmetic ensemble model may comprise a weighted sum. In such example embodiment, determining the prospective priority score may include performing the operation described by the below equation.

S=(P1*α1)*(P2*α2) Equation 2

In equation 2:
S is the prospective priority score for a predictive input entity,
P1 is the prospective qualifying criteria satisfaction predictive output for the predictive input entity (e.g., likelihood of coordination of benefits),
P2 is the prospective triggering event occurrence predictive output for the predictive input entity (likelihood of claim filing/likelihood of high-value claim filing),
α1 is the nominal weight value for the prospective qualifying criteria satisfaction predictive output P1, and
α2 is the nominal weight value for the prospective triggering event occurrence predictive output P2.

In some embodiments, additionally, the prospective prioritization computing entity 106 may determine a prospective cost predictive output 613 with respect to each predictive input entity. The prospective cost predictive output 613 may be a magnitude predictive output (e.g., monetary amount) corresponding with an event which triggers an interest with respect to a predictive input entity. In such embodiments, determining the prospective priority score may include performing the operation described by the below equation:

S=P1*P2*P3 Equation 3

In equation 3:
S is the prospective priority score for a predictive input entity,
P1 is the prospective qualifying criteria satisfaction predictive output for the predictive input entity (e.g., likelihood of coordination of benefits),
P2 is the prospective triggering event occurrence predictive output for the predictive input entity (likelihood of claim filing/likelihood of high-value claim filing), and
P3 is the prospective cost predictive output for the predictive input entity.

In an example embodiment, the arithmetic ensemble model may comprise a weighted sum, where, determining the prospective priority score may include performing the operation described by the below equation.

S=(P1*α1)*(P2*α2)*(P3*α3) Equation 4

In equation 4:
S is the prospective priority score for a predictive input entity,
P1 is the prospective qualifying criteria satisfaction predictive output for the predictive input entity (e.g., likelihood of coordination of benefits),
P2 is the prospective triggering event occurrence predictive output for the predictive input entity (likelihood of claim filing/likelihood of high-value claim filing),
P3 is the prospective cost predictive output for the predictive input entity,
α1 is the nominal weight value for the prospective qualifying criteria satisfaction predictive output P1,
α2 is the nominal weight value for the prospective triggering event occurrence predictive output P2, and
α3 is the nominal weight value for the prospective cost predictive output P3.

In some embodiments, determining the prospective priority score may include performing the operation described by the below equation:

S=P1*P3 Equation 5

In equation 5:
S is the prospective priority score for a predictive input entity,
P1 is the prospective qualifying criteria satisfaction predictive output for the predictive input entity (e.g., likelihood of coordination of benefits), and
P3 is the prospective cost predictive output for the predictive input entity.

In an example embodiment, the arithmetic ensemble model may comprise a weighted sum. In such example embodiment, determining the prospective priority score may include performing the operation described by the below equation.

S=(P1*α1)*(P3*α3) Equation 6

In equation 6:
S is the prospective priority score for a predictive input entity,
P1 is the prospective qualifying criteria satisfaction predictive output for the predictive input entity (e.g., likelihood of coordination of benefits),
P3 is the prospective cost predictive output for the predictive input entity, α1 is the nominal weight value for the prospective qualifying criteria satisfaction predictive output P1, and
α3 is the nominal weight value for the prospective cost predictive output P3.

In some embodiments, one or more of the prospective qualifying criteria satisfaction predictive output, the prospective triggering event occurrence predictive, and/or the prospective cost predictive output 613 may be substituted with static averages.

### Determining Predictive Input Channel in Relation to Prospective Cost Predictive Output

In some embodiments, determining by the prospective prioritization computing entity 106, a prospective cost predictive output 613 for a predictive input entity of a plurality of predictive input entities includes: (i) determining the predictive input channel (of a plurality of input channels) associated with the predictive input entity; (ii) determining a model of a plurality of models (e.g., supervised machine learning model) based at least in part on the predictive input channel; and (iii) determining the prospective cost predictive output 613 for the predictive input entity based at least in part on utilizing the model.

As described above, the prospective prioritization computing entity 106 can determine one of four types of predictive input channels: a rule-based prospective channel 501, a model-based prospective channel 502, a rule-based real-time channel 503, and a model-based real-time channel 504, and each input channel may correspond with a different evaluation technique.

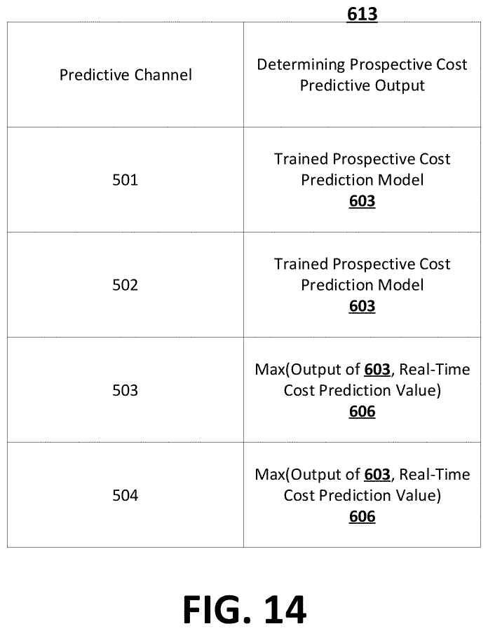

In some embodiments, as illustrated in FIG. 14, the prospective prioritization computing entity 106 may utilize a trained prospective cost prediction model 603 to determine a prospective cost predictive output 613 with respect to a predictive input entity associated with a rule-based prospective channel 501 or a model-based prospective channel 502. The trained prospective cost prediction model 603 may be a supervised machine learning model (e.g., a neural network machine learning model). The supervised machine learning model may utilize machine learning algorithms such as support vector machines, linear regression, logistic regression, naïve Bayes classifiers, decision trees, and the like.

In example embodiments, to determine a prospective cost predictive output 613 utilizing a trained prospective cost prediction model 603, the prospective prioritization computing entity 106: (i) receives per-entity historical cost data for a predictive input entity associated with a rule-based prospective channel 501 or a model-based prospective channel 502. Per-entity historical cost data may refer to a data object describing claim features. Example claim features may include a claim amount or value or a cumulative claim cost with respect to a predictive input entity, and (ii) process the per-entity historical cost data using the trained prospective cost prediction model 603 to generate the prospective cost predictive output 613.

In some embodiments, the prospective prioritization computing entity 106 may utilize a maximal triggering event occurrence predictive value 606 as the prospective cost predictive output 613 with respect to a predictive input entity associated with a rule-based real-time channel 503 or a model-based real-time channel 504. The maximal triggering event occurrence predictive value 606 may be the larger of an inferred predictive value (e.g., generated using a trained prospective cost prediction model 603) and an actual value corresponding with a triggering event occurrence, such that the actual value may be substituted for the inferred prediction value responsive to real-time triggers/events. In example embodiments, to determine the prospective cost predictive output 613 utilizing a maximal triggering event occurrence predictive value, the prospective prioritization computing entity 106: (i) receives a real-time prospective cost predictive output value (e.g., corresponding with an actual value) for a predictive input entity that is associated with the rule-based real-time channel 503 or the model-based real-time channel 504; (ii) generates an inferred prospective cost predictive output value for the predictive input entity; and (iii) generates the prospective cost predictive output 613 which is the larger of the real-time prospective cost predictive output value and the inferred prospective cost predictive output value.

### Performing Prospective Prioritization

Returning to FIG. 4, step/operation 404, the prospective prioritization computing entity 106 may perform prospective prioritization of the predictive input entities. In some embodiments, the prospective prioritization computing entity 106 performs prospective prioritization with respect to the predictive input entities based at least in part on the priority scores. By determining prospective priority scores (prospective prioritization scores) for each of the predictive input entities in a continuous manner (e.g., for predictive input entities associated with prospective channels 501, 502 and real-time channels 503, 504) a single prioritized channel/associated workflow and/or one or more queues may be generated for presentation to an end user.

A queue may refer to an ordering of a plurality of data objects describing predictive input entities and corresponding prospective prioritization scores (e.g., prospective priority scores) based at least in part on a portion of the single prioritized channel. In some embodiments, the prospective prioritization system may be configured to generate one or more API-based data objects corresponding with the single prioritized channel and/or the one or more queues. The prospective prioritization system may provide (e.g., transmit, send) the one or more API-based data objects representing at least a portion of the single prioritized channel and/or the one or more queues to an end user interface (e.g., an investigation agent user interface) for display and/or further operations.

The prospective prioritization scores and predictive outputs may be used to dynamically update the user interface (e.g., an investigation agent user interface), generate alerts, for load balancing operations or determining a distribution of resources with respect to inventory (e.g., assigning portions of inventory or data subsets to a plurality of investigative agents). An investigation agent may refer to a user (e.g., human investigation agent) or a programmatic investigation agent (e.g., artificial intelligence agent). Prospective prioritization may comprise assigning one or more predictive input entities to one of a plurality of investigation agents based at least in part on the prospective priority score of the predictive input entity and causing each investigation agent to process a related subset of the plurality of predictive input entities that is associated with the investigation agent. The system may generate an investigation agent user interface for each investigation agent that describes one or more investigation queue features of the related subset associated with the investigation agent. A queue may be assigned to an investigation agent. The user may navigate an investigation agent user interface by operating a user computing entity. Through the investigation agent user interface, the user (e.g., human investigation agent) may view and access claim inventory, claim information/data, member information/data, provider information/data, and/or the like. To do so, the prospective prioritization system may provide access to the system via a user profile that has been previously established and/or stored. In an example embodiment, a user profile comprises user profile information/data, such as a user identifier configured to uniquely identify the user, a username, user contact information/data (e.g., name, one or more electronic addresses such as emails, instant message usernames, social media user names, and/or the like), user preferences, user account information/data, user credentials, information/data identifying one or more user computing entities corresponding to the user, and/or the like.

The prospective prioritization scores may be utilized to reduce the amount of data required to make a decision or take an action with respect to a predictive input entity. Instead of conducting an extensive investigation including examining data from a plurality of channels, the prospective prioritization score for a predictive input entity provides an indication of relevance and/or a degree of relevance, facilitating faster decision making for subsequent operations. An example of an action as described herein relates to performing operational load balancing. Various embodiments of the present invention make important technical contributions to improving resource-usage efficiency of post-prediction systems by using prospective priority scores to set the number of allowed computing entities used by the noted post-prediction systems. For example, in some embodiments, a prospective prioritization computing entity determines D investigation classifications for D predictive input entities based at least in part on the D prospective priority scores for the D predictive input entities. Then, the count of D predictive input entities that are associated with an affirmative investigation classification, along with a resource utilization ratio for each document data object, can be used to predict a predicted number of computing entities needed to perform post-prediction processing operations (e.g., automated investigation operations, such as automated COB investigation operations) with respect to the D predictive input entities. For example, in some embodiments, the number of computing entities needed to perform post-prediction processing operations (e.g., automated investigation operations) with respect to D predictive input entities can be determined based at least in part on the output of the equation: R=ceil(Σₖ^{k=K}urₖ), where R is the predicted number of computing entities needed to perform post-prediction processing operations with respect to the D predictive input entities, ceil( ) is a ceiling function that returns the closest integer that is greater than or equal to the value provided as the input parameter of the ceiling function, k is an index variable that iterates over K predictive input entities among the D document data that are associated with affirmative investigative classifications, and urₖ is the estimated resource utilization ratio for a kth predictive input entity that may be determined based at least in part on a count of utterances/tokens/words in the kth predictive input entity. In some embodiments, once R is generated, a prospective prioritization computing entity can use R to perform operational load balancing for a server system that is configured to perform post-prediction processing operations (e.g., automated investigation operations) with respect to D predictive input entities. This may be done by allocating computing entities to the post-prediction processing operations if the number of currently-allocated computing entities is below R, and deallocating currently-allocated computing entities if the number of currently-allocated computing entities is above R.

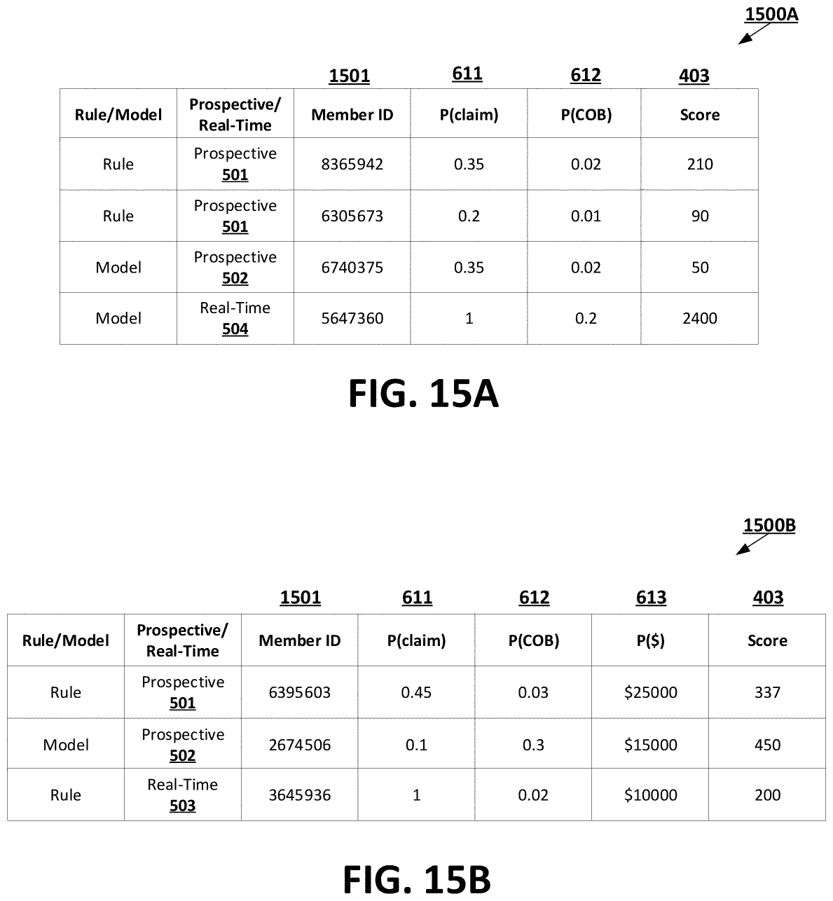

FIG. 15A-B illustrates operational examples showing an output of prospective prioritization operations 1500A-B. As shown, inventory from rule-based prospective channels 501, model-based prospective channels 502, rule-based real-time channels 503, and model-based real-time channels 504 are integrated to provide a single prioritized channel/associated workflow. Each predictive input entity may be associated with a member identifier 1501. Each member identifier 1501 may refer to a data object configured to uniquely identify/determine the member (e.g., member identifier, user identifier, and/or the like), a username, user contact information/data (e.g., name (John Doe), one or more electronic addresses such as emails, instant message usernames, social media user names, and/or the like), member preferences, member account information/data, member credentials, information/data identifying/determining one or more member computing entities corresponding to the member, and/or the like. As noted, each member record/profile may correspond to a unique username, unique user identifier (e.g., 11111111), access credentials, and/or the like.

As shown, each member identifier 1501 may correspond with a member record/profile. A member record/profile refers to a data object storing and/or providing access to member information/data. The member record/profile may also comprise member information/data, member features, and/or similar words used herein interchangeably that can be associated with a given member, claim, and/or the like. In some embodiments, member information/data can include age, gender, employment status, known health conditions, home location, profession, access to medical care, medical history, claim history, member identifier (ID), and/or the like. Member information/data may also include marital status, employment status, employment type, socioeconomic information/data (e.g., income information/data), relationship to the primary insured, insurance product information/data, insurance plan information/data, member classifications, language information/data, and/or the like. Each member identifier 1501 may correspond with an entry, such as a table/database entry indicating the corresponding prospective qualifying criteria satisfaction predictive output 612, prospective triggering event occurrence predictive output 611, prospective cost predictive output 613, and/or the prospective prioritization score that is the output of the step/operation 403. In some embodiments, the member identifiers 1501/entries may be presented (sorted, organized, arranged, and/or the like) in accordance with their prospective prioritization score/investigation priority.

Investigation priority may refer to an ordering of data objects describing a plurality of prospective prioritization scores (e.g. prospective priority scores) associated with each of a plurality of predictive input entities. The prospective prioritization system may generate a single prioritized channel, associated workflow and/or one or more queues based at least in part on the prospective prioritization scores corresponding with each predictive input entity. In the context of coordination of benefits, the single prioritized channel and/or one or more queues may comprise a plurality of member identifiers, each associated with a predictive input entity, organized in accordance with a corresponding prospective priority score. In some embodiments, the investigation priority may be defined with respect to a qualifying condition.

In various embodiments, the user profile may be associated with one or more queues assigned to the investigation agent. The queues can be updated continuously, regularly, and/or in response to certain triggers. Moreover, the queues may be any of a variety of data structures that allow for efficient and dynamic prioritization and reprioritization, such as array data structures, heap data structures, map data structures, linked list data structures, tree data structures, and/or the like. Dynamically updating a queue associated with a particular investigation agent can cause an active investigation agent user interface with which the user is interacting to automatically be updated. In other embodiments, an investigation agent may be an artificial investigation agent, such as artificial intelligence (AI) bots that can perform at least some or a subset of the functions of a human investigation agent. In such an embodiment, each artificial investigation agent can be associated with one or more queues and benefit from the techniques and approaches described herein.

In some embodiments, a queue assigned to a particular user can be provided by the prospective prioritization system 101 (e.g., via a client computing entity 102) for accessing, viewing, investigating, and/or navigating via a user interface 1600 being displayed by an investigation agent user computing entity. Thus, the user interface 1600 can be dynamically updated to reflect the most current investigation priority order of claims, for example, assigned to a user (e.g., human investigation agent) at any given time. For instance, if a claim is received, the prospective prioritization system 101 (e.g., via a client computing entity 102) can push an update to the corresponding queue and update the investigation priority order of the queue. In another embodiment, the user interface 1600 may dynamically update the queue being displayed on a continuous or regular basis or in response to certain triggers.

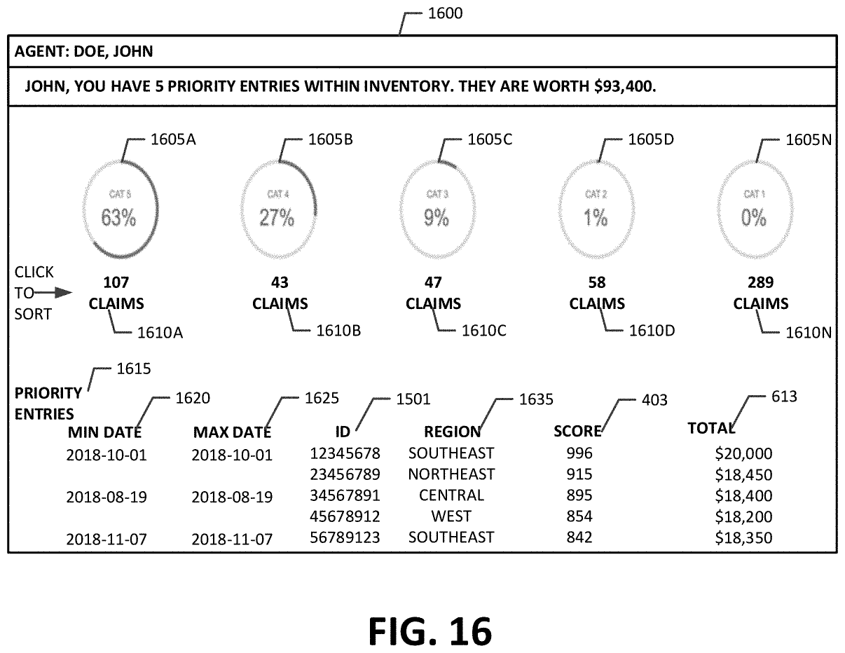

As shown in FIG. 16, the user interface 1600 may comprise various features and functionality for accessing, viewing, investigating, and/or navigating claims in open inventory or in a queue. In one embodiment, the user interface 1600 may identify the user (e.g., investigation agent) credentialed for currently accessing the user interface 1600 (e.g., John Doe). The user interface 1600 may also comprise messages to the user in the form of banners, headers, notifications, and/or the like.

In one embodiment, the user interface 1600 may display one or more claim category elements 1605A-1605N. The terms elements, indicators, graphics, icons, images, buttons, selectors, and/or the like are used herein interchangeably. In one embodiment, the claim category elements 1605A-1605N may represent respective queues assigned to a credentialed user. For example, claim category element 1605A may represent a first queue assigned to a user, claim category element 1605B may represent a second queue assigned to the user, and so on. In another embodiment, the claim category element 1605A-1605N may represent portions of a single queue assigned to the user based at least in part on threshold amounts. For example, the claim category element 1605A may represent claims having a prospective prioritization score within a first threshold, the claim category element 1605B may represent claims having a prospective prioritization score within a second threshold, and so on. In yet another embodiment, the claim category elements 1605A-1605N may comprise all of the claims in open inventory and allow for reviewing the status of claims within particular thresholds. In one embodiment, each claim category element 1605A-1605N may be selected to control what the user interface 1600 displays as the information/data in elements 1615, 1620, 1625, 1501, 1635, 1640, 613, and/or the like, as well as the output of the step/operation 403. For example, if a claim category element 1605A is selected via an investigation agent user interface, elements 1615, 1620, 1625, 1501, 1635, 1640, 613, as well as the output of the step/operation 403, are dynamically populated with information/data corresponding to priority entries (e.g., entries with the highest prospective prioritization scores).

In one embodiment, each claim category element 1605A-1605N may further be associated with category sort elements 1610A-1610N. The category sort elements 1610A-1610N may be selected to control how the user interface 1600 sorts and displays the information/data in elements 1615, 1620, 1625, 1501, 1635, 1640, 613, and/or the like, as well as the output of the step/operation 403.

In one embodiment, elements 1615, 1620, 1625, 1501, 1635, 1640, 613 and/or the like, as well as the output of the step/operation 403, may include claims (and at least a portion of their corresponding information/data) for a particular category. For example, element 1615 may be selectable for sorting and represent the category of claims selected via a claim category element 1605A-1605N. Elements 1620 and 1625 may be selectable elements for sorting and represent minimum/maximum dates the claims were submitted. Element 1501 may be selectable for sorting and represent the ID of the claim, the ID of a provider who submitted the claim, the ID of a member to whom the claim corresponds, a tax identification number of a provider, and/or the like. Element 1635 may be selectable for sorting and represent location information for the corresponding claim line. The output of the step/operation 403 may be selectable for sorting and represent the prospective prioritization score and/or information relating to the claims being displayed. The element corresponding to the prospective cost predictive output 613 may be selectable for sorting and represent the associated prospective cost predictive output or actual claim amount. As will be recognized, the described elements are provided for illustrative purposes and are not to be construed as limiting the dynamically updatable interface in any way. As indicated above, the user interface 1600 can be dynamically updated to show the most current investigation priority order of claims at an inventory level, a queue level, and/or the like.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for performing prospective prioritization of a plurality of predictive input entities, the computer-implemented method comprising:
for each predictive input entity of the plurality of predictive input entities,
determining, using one or more processors, a prospective qualifying criteria satisfaction predictive output for the predictive input entity;
determining, using the one or more processors, a prospective triggering event occurrence predictive output for the predictive input entity based at least in part on a trained prospective prediction machine learning model, wherein training the prospective prediction machine learning model comprises:
identifying, using the one or more processors, a plurality of retrospective events associated with a defined retrospective period;
identifying, using the one or more processors, a plurality of prospective events associated with the plurality of retrospective events associated with a defined prospective period, each prospective event of the plurality of prospective events having an event valuation;
for each prospective event, determining, using the one or more processors, a prospective-period training utility measure;
determining, using the one or more processors, a high-utility subset of the plurality of prospective events based at least in part on each prospective-period training utility measure;
determining, using the one or more processors, a periodic ground-truth value for the defined prospective period based at least in part on each event valuation for the high-utility subset;
generating, using the one or more processors, training data for the prospective prediction machine learning model based at least in part on the periodic ground-truth value;
training, using the one or more processors, the prospective prediction machine learning model based at least in part on the training data;
determining, using the one or more processors, a prospective priority score for the predictive input entity based at least in part on the prospective qualifying criteria satisfaction predictive output for the predictive input entity and the prospective triggering event occurrence predictive output for the predictive input entity; and
performing, using the one or more processors, prospective prioritization based at least in part on each prospective priority score for a predictive input entity of the plurality of predictive input entities.

2. The computer-implemented method of claim 1, wherein:
each prospective qualifying criteria satisfaction predictive output for a predictive input entity of the plurality of predictive input entities describes a likelihood of coordination of benefits with respect to the predictive input entity; and
each prospective triggering event occurrence predictive output for a predictive input entity of the plurality of predictive input entities describes a likelihood of claim filing with respect to the predictive input.

3. The computer-implemented method of claim 1, wherein the prospective priority score for each predictive input entity of the plurality of predictive input entities describes an investigation priority of the predictive input entity.

4. The computer-implemented method of claim 1, wherein training the prospective prediction machine learning model further comprise:
for each retrospective event, determining a retrospective-period training utility measure;
determining a high-utility subset of the plurality of retrospective events based at least in part on each retrospective-period training utility measure; and
generating the training data based at least in part on the high-utility subset of the plurality of retrospective events.

5. The computer-implemented method of claim 1, wherein the prospective-period training utility measure is determined based at least in part on each event valuation associated with each prospective event.

6. The computer-implemented method of claim 1, further comprising:
for each predictive input entity:
determining a predictive input channel of a plurality of predictive input channels that is associated with the predictive input entity; and
determining a model for determining the prospective qualifying criteria satisfaction predictive output based at least in part on the predictive input channel.

7. The computer-implemented method of claim 6, wherein the plurality of predictive input channels comprises a model-based prospective channel, a rule-based prospective channel, a model-based real-time channel, and a rule-based real time channel.

8. The computer-implemented method of claim 1, wherein performing the prospective prioritization comprises:
assigning each predictive input entity of the plurality of predictive input entities to an investigation agent of one or more investigation agents based at least in part on the prospective priority score of the predictive input entities, and
causing each investigation agent of the one or more investigation agents to process related subset of the plurality of predictive input entities that is associated with the investigation agent.

9. The computer-implemented method of claim 8, further comprising:
for each investigation agent of the one or more investigation agents, generating an investigation agent user interface for the investigation agent that describes one or more investigation queue features of the related subset associated with the investigation agent.

10. An apparatus for performing prospective prioritization of a plurality of predictive input entities, the apparatus comprising at least one processor and at least one memory including program code, the at least one memory and the program code configured to, with the processor, cause the apparatus to at least:
for each predictive input entity of the plurality of predictive input entities,
determine a prospective qualifying criteria satisfaction predictive output for the predictive input entity;
determine a prospective triggering event occurrence predictive output for the predictive input entity based at least in part on a trained prospective prediction machine learning model, wherein training the prospective prediction machine learning model comprises:
identifying a plurality of retrospective events associated with a defined retrospective period;
identifying a plurality of prospective events associated with the plurality of retrospective events associated with a defined prospective period, each prospective event of the plurality of prospective events having an event valuation;
for each prospective event, determining a prospective-period training utility measure;
determining a high-utility subset of the plurality of prospective events based at least in part on each prospective-period training utility measure;
determining a periodic ground-truth value for the defined prospective period based at least in part on each event valuation for the high-utility subset;
generating training data for the prospective prediction machine learning model based at least in part on the periodic ground-truth value;
training the prospective prediction machine learning model based at least in part on the training data;
determining a prospective priority score for the predictive input entity based at least in part on the prospective qualifying criteria satisfaction predictive output for the predictive input entity and the prospective triggering event occurrence predictive output for the predictive input entity; and
perform prospective prioritization based at least in part on each prospective priority score for a predictive input entity of the plurality of predictive input entities.

11. The apparatus of claim 10, wherein:
each prospective qualifying criteria satisfaction predictive output for a predictive input entity of the plurality of predictive input entities describes a likelihood of coordination of benefits with respect to the predictive input entity; and
each prospective triggering event occurrence predictive output for a predictive input entity of the plurality of predictive input entities describes a likelihood of claim filing with respect to the predictive input.

12. The apparatus of claim 10, wherein the prospective priority score for each predictive input entity of the plurality of predictive input entities describes an investigation priority of the predictive input entity.

13. The apparatus of claim 10, wherein training the prospective prediction machine learning model further comprise:
for each retrospective event, determining a retrospective-period training utility measure;
determining a high-utility subset of the plurality of retrospective events based at least in part on each retrospective-period training utility measure; and
generating the training data based at least in part on the high-utility subset of the plurality of retrospective events.

14. The apparatus of claim 10, wherein the prospective-period training utility measure is determined based at least in part on each event valuation associated with each prospective event.

15. The apparatus of claim 10, wherein the at least one memory and the program code are further configured to cause the apparatus to at least:
for each predictive input entity:
determine a predictive input channel of a plurality of predictive input channels that is associated with the predictive input entity; and
determine a model for determining the prospective qualifying criteria satisfaction predictive output based at least in part on the predictive input channel.

16. The apparatus of claim 15, wherein the plurality of predictive input channels comprises a model-based prospective channel, a rule-based prospective channel, a model-based real-time channel, and a rule-based real-time channel.

17. The apparatus of claim 10, wherein performing the prospective prioritization comprises:
assigning each predictive input entity of the plurality of predictive input entities to an investigation agent of one or more investigation agents based at least in part on the prospective priority score of the predictive input entities, and
causing each investigation agent of the one or more investigation agents to process related subset of the plurality of predictive input entities that is associated with the investigation agent.

18. The apparatus of claim 17, wherein the at least one memory and the program code are further configured to cause the apparatus to at least:
for each investigation agent of the one or more investigation agents, generate an investigation agent user interface for the investigation agent that describes one or more investigation queue features of the related subset associated with the investigation agent.

19. A computer program product for performing prospective prioritization of a plurality of predictive input entities, the computer program product comprising at least one non-transitory computer-readable storage medium having computer-readable program code portions stored therein, the computer-readable program code portions configured to:
for each predictive input entity of the plurality of predictive input entities,
determine a prospective qualifying criteria satisfaction predictive output for the predictive input entity;
determine a prospective triggering event occurrence predictive output for the predictive input entity based at least in part on a trained prospective prediction machine learning model, wherein training the prospective prediction machine learning model comprises:
identifying a plurality of retrospective events associated with a defined retrospective period;
identifying a plurality of prospective events associated with the plurality of retrospective events associated with a defined prospective period, each prospective event of the plurality of prospective events having an event valuation;
for each prospective event, determining a prospective-period training utility measure;
determining a high-utility subset of the plurality of prospective events based at least in part on each prospective-period training utility measure;
determining a periodic ground-truth value for the defined prospective period based at least in part on each event valuation for the high-utility subset;
generating training data for the prospective prediction machine learning model based at least in part on the periodic ground-truth value;
training the prospective prediction machine learning model based at least in part on the training data;
determining a prospective priority score for the predictive input entity based at least in part on the prospective qualifying criteria satisfaction predictive output for the predictive input entity and the prospective triggering event occurrence predictive output for the predictive input entity; and
perform prospective prioritization based at least in part on each prospective priority score for a predictive input entity of the plurality of predictive input entities.

20. The computer program product of claim 19 wherein:
each prospective qualifying criteria satisfaction predictive output for a predictive input entity of the plurality of predictive input entities describes a likelihood of coordination of benefits with respect to the predictive input entity; and
each prospective triggering event occurrence predictive output for a predictive input entity of the plurality of predictive input entities describes a likelihood of claim filing with respect to the predictive input.
